(19) United States
(12) Patent Application Publication
(10) Pub. No.: US 2026/0289646 A1
(43) Pub. Date: Sep. 24, 2026

(54) SYSTEM

(71) Applicant: SoftBank Group Corp., Tokyo (JP)

(72) Inventor: Koga KOBAYASHI, Tokyo (JP)

(73) Assignee: SoftBank Group Corp., Tokyo (JP)

(21) Appl. No.: 19/558,518

(22) Filed: Mar. 6, 2026

(30) Foreign Application Priority Data
Mar. 19, 2025 (JP) 2025-044484

(51) Int. Cl. G06Q 30/0601; G06N 3/0475

(52) U.S. Cl. CPC G06Q 30/06311; G06N 3/0475

(57) ABSTRACT

A system includes a processor that is configured to provide an interface for receiving information from a user, use a generative AI model to analyze the received information by using a prompt that instructs the generative AI model to predict an interest or an emotion of the user and to generate information having a high relevance to the user, and perform communication to notify the generated information to the user in real time.

### CROSS-REFERENCE TO RELATED APPLICATION

This application is based on and claims priority under 35 USC 119 from Japanese Patent Application No. 2025-044484 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional information provision systems typically deliver static or broadly targeted content that does not sufficiently reflect a user's current intent, interest, or emotional state. Such systems generally rely on predefined rules or simple user profiling, and therefore cannot flexibly adapt to nuanced user inputs or rapidly changing contexts. As a result, the user often receives information that is not optimally relevant or timely, leading to decreased user satisfaction and inefficient information acquisition. Furthermore, existing systems do not fully leverage generative AI models for dynamically interpreting complex user inputs, including behavior history, search history, and emotional cues, nor do they provide a mechanism to notify highly relevant generated information to the user in real time. Accordingly, there is a need for a system that can analyze user information by using a generative AI model, accurately predict user interests and emotional states, and provide highly relevant, personalized information to the user in real time.

### SUMMARY

In order to solve the above-described problems, according to one aspect of the present invention, there is provided a system comprising a processor, wherein the processor is configured to provide an interface for receiving information from a user, use a generative AI model to analyze the received information by using a prompt that instructs the generative AI model to predict an interest or an emotion of the user and to generate information having a high relevance to the user, and perform communication to notify the generated information to the user in real time. In one embodiment, the processor is configured to input a behavior history or a search history of the user as a prompt, and instruct the generative AI model to generate personalized information, thereby enabling customization of information according to past user activities. In another embodiment, the processor is configured to analyze an emotional state of the user, provide a result of the analysis to the generative AI model as a prompt, and instruct the generative AI model to generate information based on the result, thereby allowing the system to adapt the content and tone of the information according to the user's emotional condition and to improve the relevance and immediacy of the information provided.

The term “system” refers to an integrated combination of hardware, software, and communication components that cooperatively perform processing for receiving information from a user, analyzing the information by using a generative AI model, and providing generated information to the user.

The term “processor” refers to one or more hardware processing units, such as a CPU, GPU, or specialized AI accelerator, and may include associated control logic that executes programs or instructions to perform the functions defined in the claims.

The term “interface for receiving information from a user” refers to a hardware and/or software mechanism, such as a graphical user interface, web interface, application programming interface, or input form, through which data supplied by a user is acquired by the system.

The term “information from a user” refers to any data provided directly or indirectly by the user, including, but not limited to, text input, selections, behavior history, search history, click logs, or sensor-based input reflecting the user's actions or state.

The term “generative AI model” refers to a machine learning model, such as a neural network-based language model, image generation model, or multimodal model, that is capable of generating new data or content in response to input data and instructions.

The term “prompt” refers to a set of input data, parameters, and instructions provided to the generative AI model, which specifies how the model should interpret user-related information and what kind of output or generated information the model should produce.

The term “analyze the received information” refers to processing the user-provided information, by using the generative AI model and the prompt, to extract features, infer patterns, or derive higher-level interpretations such as predicted interests or emotional states.

The term “predict an interest of the user” refers to inferring, from the received information and optionally historical data, a topic, product, service, or category that is likely to be relevant or desirable to the user at a given time.

The term “predict an emotion of the user” refers to inferring an emotional state of the user, such as satisfaction, frustration, happiness, or anxiety, based on the user's input, behavior, or other observable signals.

The term “information having a high relevance to the user” refers to information, including recommendations or responses, that closely matches the user's inferred interests, needs, or emotional state, as determined by the analysis performed by the generative AI model.

The term “perform communication to notify the generated information to the user in real time” refers to transmitting the generated information from the system to a user device with a latency that is sufficiently low for the user to receive the information substantially immediately in the context of an ongoing interaction or session.

The term “behavior history of the user” refers to a record of past user actions, such as page views, clicks, purchases, navigations, or interactions with content or services, which are stored and used as input for the generative AI model.

The term “search history of the user” refers to a record of search queries, search terms, and related search activities previously executed by the user, which are stored and used as input for the generative AI model.

The term “personalized information” refers to generated content, recommendations, or responses that are customized for a specific user based on that user's behavior history, search history, or emotional state.

The term “emotional state of the user” refers to a psychological condition or affective status of the user, such as mood or sentiment, that can be inferred from the user's inputs, expressions, or interaction patterns.

The term “result of the analysis” refers to data derived from processing the user's information, including predicted interests, emotional states, or other inferred attributes, which is subsequently provided to the generative AI model as part of a prompt.

The term “generate information based on the result” refers to the operation of the generative AI model producing output content that is conditioned on, and influenced by, the analysis result, so that the content is adapted to the user's predicted interests or emotional state.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

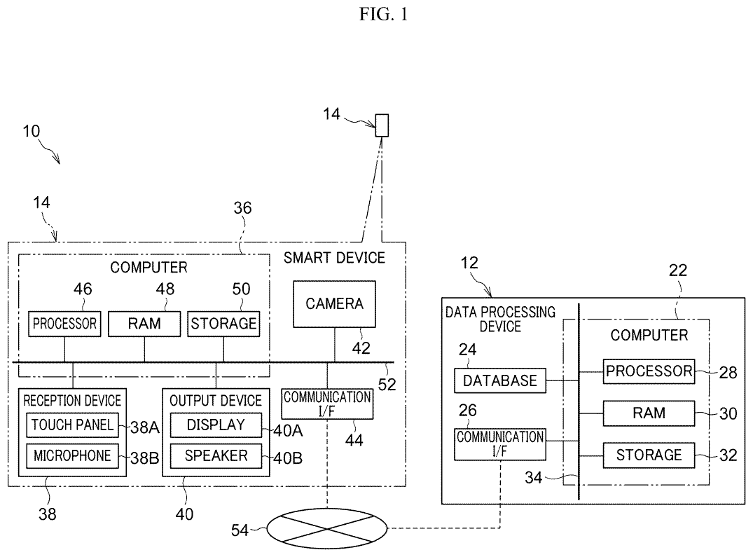

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

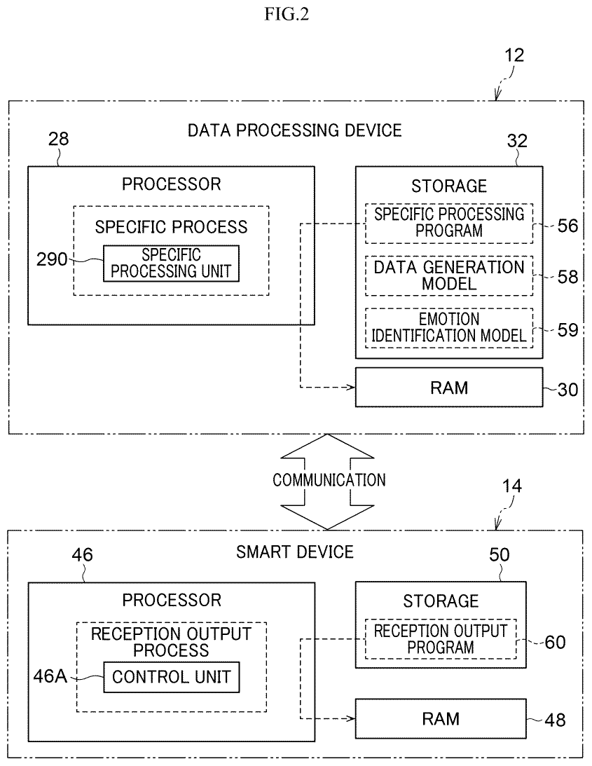

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional information provision systems that use generative AI models typically accept a single user query and return a generic response without deeply integrating multiple heterogeneous data sources or continuously adapting to user behavior. In such systems, a processor often forwards a user's textual input directly to a generative AI model, optionally with simple search results, and relays the model's output to a user interface. This architecture exhibits several technical limitations.

First, the processor generally lacks an internal mechanism to compute and maintain a structured, machine-usable representation of the user's long-term and short-term interests based on behavior history and search history. As a result, the system cannot effectively transform raw behavioral log data into a stable, reusable context representation, and the generative AI model receives only a shallow or incomplete context. This causes inefficiencies in the use of computational resources of the generative AI model, because the model must repeatedly infer user intent from scratch, and leads to unstable response quality.

Second, conventional systems do not provide a robust, processor-executed pipeline for automatically generating and updating prompt sentences for the generative AI model based on the evolving interest representation and the current browsing context. Instead, prompt engineering is either static or manually configured, so that the processor cannot programmatically refine prompts in response to feedback signals. This results in suboptimal utilization of the generative AI model, increased token usage, and degraded personalization.

Third, existing architectures often treat organization-owned information, such as internal databases and document repositories, as an external add-on. The processor typically performs a simple keyword search and passes unstructured results to the generative AI model without systematically integrating those results with the user's characteristic information and the current content being viewed. Consequently, the generative AI model receives unbalanced or noisy context, which may cause hallucinations, omission of relevant internal records, and increased latency due to unnecessary data transfer.

Fourth, conventional user interfaces for AI-generated content are not tightly coupled with the server-side personalization logic. Generated information is often displayed as a separate page or modal dialog, and interaction events (for example, selection, detail request, or dismissal) are not captured or processed as structured feedback by the processor. This prevents the system from using real-time feedback to adjust interest weights and prompt generation logic, reducing the system's ability to continuously improve relevance and computational efficiency.

Accordingly, there is a need for a system architecture and processing method in which a processor: (i) derives and maintains characteristic information that encodes user interests from behavior history and search history using natural language processing; (ii) automatically generates and updates prompt sentences for a generative AI model based on that characteristic information, the current information resource context, and organization-owned information retrieved from an information management apparatus; (iii) supplies integrated input information to the generative AI model in a structured and constrained manner; and (iv) acquires structured feedback from a user terminal to update weighting of topics and phrases. Such a system can improve the operation of the computer itself by reducing redundant computation in the generative AI workflow, improving data handling efficiency between components, and enhancing the accuracy and stability of personalized information generation.

The specific processing by the specific processing unit 290 of the data processing device 12 in Example 1 is realized by the following means.

The present invention provides a server comprising a processor and a memory storing instructions that, when executed by the processor, cause the processor to acquire user behavior information and information resource information from one or more information acquisition units, generate characteristic information indicating user interests for each user based on the acquired information, automatically generate a prompt sentence for a generative AI model based on the characteristic information and context information relating to an information resource currently being browsed by the user, retrieve organization-owned information from an information management apparatus on the basis of the prompt sentence and the characteristic information, generate integrated input information including the prompt sentence, the characteristic information, the organization-owned information, and content information relating to the information resource currently being browsed by the user, cause the generative AI model to generate integrated information from the integrated input information, transmit the integrated information to a user terminal for display in association with the information resource currently being browsed by the user, acquire operation information and reaction information of the user with respect to the displayed integrated information, and update the characteristic information and one or more generation conditions of the prompt sentence on the basis of the acquired operation information and reaction information. This enables a computer-implemented pipeline in which the server autonomously constructs and refines structured user interest representations, dynamically optimizes prompt sentences, and selectively integrates internal organizational data into the generative AI model input, thereby improving computational efficiency, reducing unnecessary data processing, and enhancing the technical performance and personalization quality of AI-based information provision.

The term “user behavior information” refers to information indicating one or more actions of a user in relation to one or more information resources, including, for example, page visit events, scrolling operations, selection operations, dwell times, and search inputs.

The term “information resource information” refers to information indicating attributes of one or more information resources accessed by a user, including, for example, identifiers, addresses, titles, metadata, and content summaries of the information resources.

The term “characteristic information” refers to structured information that represents one or more inferred interests, preferences, or focus topics of a user, the structured information being derived from user behavior information and history information by applying a data processing method.

The term “context information” refers to information indicating a current state relating to an information resource being browsed by a user, including, for example, a current page identifier, current content metadata, and one or more keywords or topics associated with the current information resource.

The term “prompt sentence” refers to a text string formatted as an instruction or request that is provided as at least part of an input to a generative AI model in order to control or guide generation of output information.

The term “generative AI model” refers to an information processing model implemented by software and executed on hardware, the model being configured to generate text or other data by applying one or more machine learning techniques based on an input including at least a prompt sentence.

The term “organization-owned information” refers to information stored and managed within a computing environment of an organization, the information including, for example, structured records, unstructured documents, and internal knowledge data that are not primarily provided by external public sources.

The term “information management apparatus” refers to a computing apparatus, including hardware and software, configured to store, index, and provide organization-owned information in response to one or more queries.

The term “integrated input information” refers to information that combines a prompt sentence, characteristic information, organization-owned information, and content information relating to an information resource, the combined information being provided as input to a generative AI model.

The term “integrated information” refers to output information generated by a generative AI model from integrated input information, the output information including at least a synthesized or personalized explanation, summary, recommendation, or other content.

The term “user terminal” refers to an information processing device operated by a user, including, for example, a computing device, a display unit, and an input unit, and configured to present information resources and integrated information to the user.

The term “operation information” refers to information indicating one or more user operations performed in relation to displayed integrated information, including, for example, selection operations, detail request operations, and non-relevance designation operations.

The term “reaction information” refers to information indicating a response of a user to displayed integrated information, the response being derived, for example, from interaction patterns, dwell times, or explicit user feedback.

The term “history information” refers to information indicating one or more past actions or past queries of a user over time, including behavior history information and search history information.

The term “behavior history information” refers to accumulated user behavior information collected over a plurality of sessions or time periods, the accumulated information representing historical access patterns to one or more information resources.

The term “search history information” refers to accumulated information indicating one or more search queries issued by a user to one or more search functions or search services over a plurality of sessions or time periods.

The term “natural language processing method” refers to a data processing method implemented by software and executed by a processor, the method being configured to analyze or transform text data, including, for example, tokenization, part-of-speech tagging, named entity recognition, topic extraction, and phrase extraction.

The term “topic information” refers to information indicating one or more abstract subjects or themes inferred from text data, the information being represented, for example, as one or more topic labels or topic identifiers.

The term “phrase information” refers to information indicating one or more phrases or word sequences extracted from text data, the information optionally including weighting values associated with the phrases.

The term “entity information” refers to information indicating specific named or identifiable concepts extracted from text data, including, for example, product names, categories, technical terms, or other identifiable items.

The term “data storage apparatus” refers to one or more computing devices, including memory and storage units, configured to store, maintain, and provide access to history information and other data.

The term “display unit” refers to a component of a user terminal that presents visual information to a user, including, for example, a screen or a display panel and associated control circuitry.

The term “popup display” refers to a visual presentation mode in which content is displayed in a window or area that is overlaid on at least a portion of an existing display area and is independently controllable.

The term “sidebar display” refers to a visual presentation mode in which content is displayed in a vertically or horizontally aligned region adjacent to a main display area in which an information resource is presented.

The term “weight” refers to a numerical value or parameter used to indicate a relative importance or priority of topic information, phrase information, or entity information within characteristic information.

The term “generation conditions of the prompt sentence” refers to one or more parameters, rules, or templates used by a processor to construct or modify a prompt sentence, including, for example, selected topics, phrases, and their associated weights.

In one embodiment, a server includes a processor, a main memory, a non-volatile storage device, and a network interface. The server executes a program stored in the non-volatile storage device and loaded into the main memory. The program is implemented, for example, using a programming language such as Python, Java, or C++, and is executed on an operating system such as a general-purpose server operating system. The server communicates with one or more user terminals over a communication network such as the Internet or a local area network.

The server stores, in the non-volatile storage device, a relational database that maintains behavior history information and search history information. The server uses a relational database management system such as a generic SQL database engine. The server also stores an information management database that holds organization-owned information, and may optionally use a document index engine such as a full-text search engine. The server further stores a model execution module configured to communicate with a generative AI model. The generative AI model is implemented as a neural network parameter set, either deployed locally on the server or accessed via a remote model execution service.

The server uses a natural language processing method to analyze history information and information resource information. The server is configured to employ, for example, a tokenization algorithm, a part-of-speech tagging algorithm, a named entity recognition algorithm, and a topic extraction algorithm. The server may use a library such as a generic NLP toolkit, which provides functions for tokenization, lemmatization, and entity extraction. The server stores intermediate results, such as token sequences, topic identifiers, and entity identifiers, in structured data records in the relational database or in in-memory data structures such as associative arrays or data tables.

The server manages a generative AI model that is implemented as a transformer-based neural network. The server uses a model architecture that includes a plurality of attention layers, feed-forward layers, and normalization layers. The server manages model parameters, including weight matrices and bias vectors for each layer. The server obtains a trained parameter set by performing or receiving an offline training process in which the model is trained on a large corpus of text data using a supervised or self-supervised learning method. In such a training method, the server (or another training apparatus) minimizes a loss function such as a cross-entropy loss between predicted tokens and ground-truth tokens, and updates the model parameters by applying an optimization algorithm such as stochastic gradient descent or a variant thereof. The server may also perform fine-tuning of the generative AI model on organization-specific text data, adjusting the model's parameters using additional loss terms or regularization parameters to adapt the model output to internal terminology and style.

The server generates characteristic information indicating user interests by processing behavior history information and search history information stored in the relational database. The server uses the natural language processing method to convert raw text data from visited pages and search queries into a normalized representation. The server applies tokenization to split text into tokens, removes stopwords, and performs lemmatization. The server then calculates frequency statistics and applies a topic modeling algorithm, such as a latent topic decomposition method, to infer topic information. The server extracts phrase information and entity information by running a phrase extraction algorithm and a named entity recognition algorithm on the normalized text. The server stores, for each user, characteristic information as a structured record that includes a plurality of topics, phrases, entities, and associated weights representing their importance. The server may represent this information in a data structure such as a key-value map or a vector, where each key or index corresponds to a topic or phrase and each value corresponds to a weight.

The server generates a prompt sentence to provide as input to the generative AI model. The server constructs the prompt sentence according to a template-based generation procedure. The server selects one or more topics and phrases from the characteristic information based on their weights, retrieves context information relating to an information resource currently being browsed by the user, and inserts the selected elements into a text template. The server thus generates, for example, a prompt sentence such as:

“Generate information about the latest smartphone reviews tailored to a user interested in camera performance, battery life, and price.”

The server may further refine the prompt sentence using a second-stage optimization procedure. The server applies a rule set that modifies the wording based on length constraints, specificity requirements, and inclusion of technical attributes. The server thereby produces refined prompt sentences such as:

“Provide a concise, user-friendly comparison of the latest flagship smartphones, focusing specifically on camera quality, battery life, and pricing, adapted to a user who has recently read multiple smartphone review articles.”

or

“Provide a detailed price and value comparison of the latest flagship smartphones, prioritizing battery life and overall cost-effectiveness.”

By selecting topics and phrases based on characteristic information and by applying non-trivial weighting and template rules, the server configures the generative AI model to receive a compact but information-rich input, which improves both generation accuracy and computational efficiency.

The server retrieves organization-owned information from an information management apparatus. The server sends a query to the information management apparatus using a query generation module. The server generates the query based on topic information, phrase information, and entity information contained in the characteristic information and context information. For example, when the user has viewed multiple pages relating to “latest smartphone reviews,” the server generates a query to the organization's product database requesting records of recently released devices with camera and battery attributes. The server receives the retrieved records and transforms them into a structured textual representation, concatenating key attributes into text segments separated by delimiters. The server may generate text segments such as:

“Device A: 5000 mAh battery, triple-lens camera, mid-range price.”

“Device B: 4500 mAh battery, dual-lens camera, premium price.”

The server builds integrated input information by combining the prompt sentence, the characteristic information, the organization-owned information, and content information relating to the information resource currently being browsed by the user. The server encapsulates these components into a model input structure. The server may format the input as a sequence of tokens where specific markers distinguish prompt instructions, user context, and organization-owned data. Because the server explicitly controls the structure and ordering of this integrated input information, the server reduces irrelevant context and ensures that the generative AI model allocates attention to important elements, thereby reducing processing overhead in attention layers.

The server invokes the generative AI model using the integrated input information. The server provides the model input to a model execution module that applies the transformer layers to compute output token probabilities. The server sets model parameters such as maximum token length, decoding strategy (for example, beam search, top-k sampling, or nucleus sampling), and temperature, according to configuration values stored in the memory. The server then receives generated tokens representing integrated information from the model execution module. The integrated information includes synthesized content that is tailored to the user's characteristic information, the current context, and organization-owned information.

The server performs post-processing on the integrated information. The server segments the generated text into sections such as a summary portion, a detail portion, and a recommendation portion, by scanning for textual markers or headings. The server may apply filters to remove extraneous content and to enforce length limits for display on a user terminal. The server then stores the generated integrated information together with an identifier of the prompt sentence and an identifier of the user in the relational database, enabling later analysis and reuse.

The terminal includes a processor, a display unit, an input unit, a memory, and a communication interface. The terminal executes a client application, such as a web browser or a native application, that can display information resources and integrated information. The terminal receives the integrated information from the server over the communication network. The terminal displays, on the display unit, the information resource currently being browsed by the user in a main display area, and displays the integrated information in a separate display area as a popup display or a sidebar display. The terminal associates the integrated information with the current information resource by using identifiers embedded in the server response.

The user interacts with the displayed integrated information using the input unit of the terminal. The user may perform selection operations, such as clicking on an item, perform detail request operations, such as requesting expansion of a summarized section, and perform non-relevance designation operations, such as dismissing a recommendation. The terminal captures these interaction events and generates operation information indicating the type of interaction and the associated integrated information element. The terminal sends the operation information, and optionally reaction information such as dwell time, to the server as feedback.

The server receives the operation information and reaction information from the terminal and updates the characteristic information and prompt sentence generation conditions. The server increases the weight of topics and phrases associated with integrated information elements that have been selected or expanded by the user, and decreases the weight of topics and phrases associated with integrated information elements that have been dismissed. The server updates the stored characteristic information data structure by adjusting numeric weights and normalizing them. The server updates prompt generation conditions by altering template selection rules or parameter values, such as placing greater emphasis on highly weighted topics in future prompt sentences. As a result, the server improves the precision of topic selection and reduces the inclusion of topics that the user has indicated to be irrelevant.

The server, by updating characteristic information and prompt sentence generation conditions based on structured feedback, implements a feedback loop that is not a mere automation of human editorial work. Instead, the server performs numerical optimization within a computer system, adjusting weights and templates to reduce a discrepancy between user reactions and expected relevance. This optimization leads to improved alignment of generative AI outputs with user interests, which in turn reduces redundant calls to the generative AI model and decreases average response length, improving processing speed and reducing network bandwidth consumption.

The server achieves a technical effect in data management and computation efficiency because the server converts raw behavior logs and search logs into compact characteristic information and prompt sentences that the generative AI model can process more efficiently than the raw logs. The server's use of structured characteristic information and integrated input information ensures that the generative AI model receives only the most relevant features, thereby reducing the number of tokens processed by attention layers. This reduces computation time on model hardware, such as a graphics processing unit, and improves throughput for multiple users.

The server further improves the accuracy of generated information by incorporating organization-owned information in a controlled manner. The server constructs queries to the information management apparatus based on topic and entity information rather than mere keyword matching, which increases the precision of retrieved records. The server then passes these records in a structured, delimited form within the integrated input information. Because the server organizes the data with clear boundaries and markers, the generative AI model can more reliably reference and summarize the correct records, reducing hallucination and omission. This structured integration of internal data into the model input is distinct from conventional approaches that simply concatenate unorganized documents, and provides a technical improvement in how internal databases and neural models cooperate within a computer system.

In another embodiment, the server executes a variant generative AI model architecture. The server may use an encoder-decoder architecture with attention mechanisms, where the encoder processes integrated input information and the decoder generates integrated information. The server may configure the model with different numbers of layers, different hidden state dimensions, and different attention head counts. The server may apply different loss functions during fine-tuning, such as a combination of language modeling loss and alignment loss, to improve the model's ability to follow prompt sentences while respecting constraints derived from organization-owned information. The server may also use data augmentation methods during training, such as randomly masking certain fields of organization-owned records or perturbing characteristic information, to improve model robustness to incomplete or noisy inputs.

In an alternative embodiment, the server implements a rule-based refinement module that operates in conjunction with the generative AI model. The server may first apply deterministic rules to the integrated information to check for coverage of mandatory fields, such as ensuring that specific attributes (for example, price, battery capacity, or support period) appear in the generated text when required by the prompt sentence. The server may then invoke a secondary generative AI model with a prompt sentence specifically instructing the model to fill in missing attributes or restructure the content into a desired format. This layered processing provides a non-conventional workflow that combines rule-based and model-based operations to control output structure and completeness.

In yet another embodiment, the terminal uses a caching mechanism to reduce communication load. The terminal stores recently received integrated information in a local cache in the memory. When the user revisits an information resource or performs similar interactions, the terminal first consults the cache and displays previously received integrated information while the server computes updated integrated information. The server marks cache validity periods or cache keys in its responses. This caching reduces the number of round-trip communications and improves apparent responsiveness, which is a technical improvement in network utilization and user interface latency.

In a further embodiment, the server processes characteristic information and prompt sentence generation in a batched manner for multiple users. The server groups multiple users' updates and executes vectorized computations of topic and phrase weights using numerical libraries capable of matrix operations. The server then generates multiple prompt sentences in a single pass through a template function. This batched processing decreases overhead per user and increases throughput on shared hardware resources, constituting a technical improvement in resource utilization.

The server, by implementing these specific data structures, algorithms, and neural network configurations, does not merely automate human analysis of user interests. Instead, the server reorganizes data into machine-optimized forms, performs numerical weighting and topic extraction that are not feasible to perform manually at the same scale, and uses structured prompt sentences to control an underlying generative AI model. This architecture improves the functioning of the computer system as a whole by reducing computational redundancy, reducing communication overhead, and improving the relevance and stability of generated outputs.

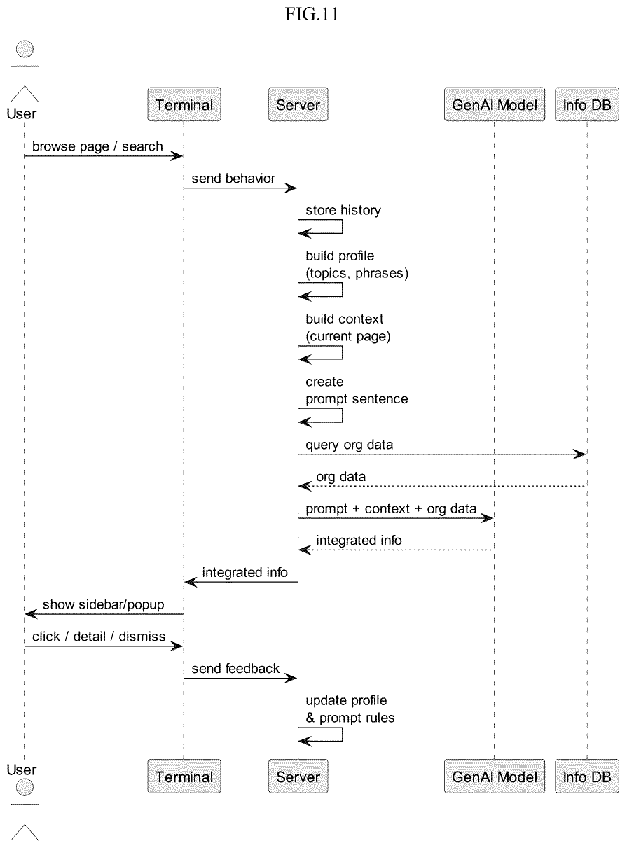

The following describes the processing flow using FIG. 11.

### Step 1

The terminal captures user behavior information while the user browses information resources. The terminal, as input, receives low-level interaction events from the operating system and browser environment, such as page load events, scroll positions, click coordinates, focus changes, and text input in search fields. The terminal, using a client-side script, aggregates these events into structured behavior records that include a page identifier, a timestamp, an event type, and optional parameters such as a query string or clicked element identifier. The terminal outputs the aggregated behavior records as JSON messages and sends them to the server via a network interface using a communication protocol such as HTTPS.

### Step 2

The server receives and stores behavior history information and search history information. The server, as input, obtains the JSON behavior records transmitted from the terminal. The server parses each JSON message, validates required fields, and normalizes resource identifiers and timestamps. The server then performs a data insertion operation into a relational database, writing each record into a behavior history table that includes columns for user identifier, resource identifier, event type, query text, and time. The server outputs persisted behavior history information and search history information stored in the database as structured rows that can be retrieved in subsequent processing.

### Step 3

The server aggregates history information to generate raw user context data. The server, as input, reads multiple rows from the behavior history table for a target user over a specified time window, such as the current session or the last 24 hours. The server executes a database query that groups rows by resource identifier and event type, and computes aggregated values such as visit counts and total dwell times. The server then constructs, in memory, a raw context structure that lists visited resources, associated query strings, and interaction statistics. The server outputs this raw context structure as a collection of records that represent the recent behavior of the user.

### Step 4

The server extracts text data and applies a natural language processing method to derive intermediate textual features. The server, as input, receives the raw context structure containing page titles, snippet texts, and search queries. The server concatenates text fields and applies tokenization, lowercasing, and stopword removal using an NLP library. The server then performs lemmatization or stemming to reduce words to base forms and applies part-of-speech tagging to classify tokens. The server outputs a set of processed token sequences and tag annotations that serve as intermediate features for topic, phrase, and entity extraction.

### Step 5

The server generates topic information, phrase information, and entity information to construct characteristic information. The server, as input, uses the processed token sequences and tag annotations from the previous step. The server applies a topic modeling algorithm to compute probability distributions over topics for the aggregated text, calculates token frequency statistics, and selects high-weight n-grams as candidate phrases. The server also runs a named entity recognition algorithm to label tokens as entities such as product names or technical terms. The server combines the resulting topics, phrases, and entities into a structured data object, assigning numeric weights based on frequency, recency, or user engagement. The server outputs characteristic information for the user in the form of a weighted list of topics, phrases, and entities.

### Step 6

The server identifies the current information resource context. The server, as input, retrieves the latest behavior record for the user, which includes the most recent resource identifier and any associated metadata such as a page title or content category. The server queries a resource metadata store or content index to obtain additional context, such as tags, summaries, and content type. The server then constructs a context information object that includes the current resource identifier, title, metadata tags, and any explicit user query associated with that resource. The server outputs this context information as a compact structure that represents the current browsing state.

### Step 7

The server generates a base prompt sentence using characteristic information and context information. The server, as input, receives the characteristic information object and the context information object. The server selects a subset of topics and phrases from the characteristic information based on the highest weights and ensures that at least one topic is relevant to the current resource metadata. The server then instantiates a text template, inserting the selected topics, phrases, and current resource descriptors into predetermined slots. The server thereby constructs a base prompt sentence such as “Generate information about the latest smartphone reviews tailored to a user interested in camera performance, battery life, and price.” The server outputs this base prompt sentence as a text string intended for use with a generative AI model.

### Step 8

The server refines the prompt sentence according to generation conditions. The server, as input, obtains the base prompt sentence and the current generation conditions, which may include desired length, required attribute coverage, and tone constraints. The server applies a rule-based transformation procedure, such as enforcing inclusion of certain attribute keywords or restructuring the sentence for clarity. The server may check for redundancy and adjust word order. The server outputs a refined prompt sentence, for example “Provide a concise, user-friendly comparison of the latest flagship smartphones, focusing specifically on camera quality, battery life, and pricing, adapted to a user who has recently read multiple smartphone review articles.”

### Step 9

The server queries an information management apparatus to retrieve organization-owned information. The server, as input, receives the characteristic information, context information, and refined prompt sentence. The server constructs a query that includes key topics, entities, and resource categories, and sends this query to the information management apparatus via a database driver or search API. The server executes search or SQL commands that filter records by attributes such as product category, release date, and feature tags. The server then collects the resulting records, which may include technical specifications, internal reports, and documentation. The server outputs a set of retrieved organization-owned information entries in a structured form suitable for conversion into text.

### Step 10

The server formats the organization-owned information and builds integrated input information. The server, as input, uses the retrieved organization-owned records and the refined prompt sentence. The server converts each record into a concise text segment, selecting relevant fields such as feature descriptions and performance metrics, and appends delimiters or headings that indicate boundaries between records. The server then concatenates the refined prompt sentence, a description of characteristic information, the formatted organization-owned information, and a summary of current context into a single integrated input structure. The server outputs this integrated input information as a tokenizable text suitable for providing to a generative AI model.

### Step 11

The server invokes the generative AI model using the integrated input information. The server, as input, takes the integrated input text and passes it to a model execution engine that implements a transformer-based neural network. The server tokenizes the input text into subword tokens, maps tokens to embeddings, and forwards them through a sequence of attention layers and feed-forward layers configured with stored model parameters. The server controls decoding parameters such as maximum output length, sampling strategy, and temperature. The server computes output token probabilities and selects tokens according to the decoding strategy to form an output sequence. The server outputs integrated information as a generated text string that synthesizes user context with organization-owned data.

### Step 12

The server post-processes the integrated information for presentation. The server, as input, receives the generated text from the generative AI model. The server parses the text to identify sections such as a summary portion, a detailed comparison portion, and a recommendation portion, using headings and delimiters inserted in the integrated input. The server may trim content that exceeds display length constraints and insert markup to represent bullet points or highlighted phrases. The server attaches identifiers linking the integrated information to the corresponding prompt sentence and user session. The server outputs a structured representation of the integrated information suitable for rendering by the terminal.

### Step 13

The server transmits the integrated information to the terminal. The server, as input, uses the structured integrated information and associated identifiers. The server generates a response message, such as a JSON payload, that includes text segments, headings, and metadata indicating where and how the content should be displayed (for example, as a sidebar or popup). The server sends this response through a communication interface to the terminal using a network protocol. The server outputs a delivered message that reaches the terminal and is ready for client-side rendering.

### Step 14

The terminal renders the integrated information alongside the current information resource. The terminal, as input, receives the response message from the server. The terminal parses the payload to extract section titles, text blocks, and display instructions. The terminal updates its graphical user interface to show the existing information resource in a main display area and to insert a new UI component, such as a sidebar or popup, containing the integrated information. The terminal applies layout rules to adjust element positions and may add interactive controls such as “More details,” “Show comparison table,” or “Not relevant” buttons. The terminal outputs a combined visual presentation where the user can simultaneously view the original resource and the personalized integrated information.

### Step 15

The user interacts with the displayed integrated information. The user, as input, receives visual content rendered by the terminal. The user may click on specific recommendation items, request expansion of a detailed section, or dismiss an entire block of integrated information. The user may also hover over elements or scroll within the sidebar. The user's actions produce interaction events that the terminal can capture. The user outputs, in effect, interaction signals that indicate preferences, interest levels, or non-relevance with respect to individual pieces of integrated information.

### Step 16

The terminal records operation information and reaction information. The terminal, as input, observes the user's interaction events such as clicks, expansions, dismissals, scroll depth, and dwell time on the integrated information component. The terminal converts these events into structured records indicating event type, target content identifier, timestamp, and optional metrics such as time spent. The terminal distinguishes between selection operations, detail request operations, and non-relevance designation operations. The terminal outputs operation information and reaction information as formatted messages and sends them to the server as feedback.

### Step 17

The server updates characteristic information and prompt sentence generation conditions based on feedback. The server, as input, receives the operation information and reaction information from the terminal. The server maps each feedback event to the corresponding topics, phrases, and entities in the characteristic information by using stored associations between integrated information segments and underlying features. The server increases weights for topics and phrases associated with positive interactions (such as selections and detail requests) and decreases weights for topics and phrases associated with non-relevance designations. The server normalizes the updated weights and stores the modified characteristic information back into the database. The server also updates prompt generation conditions, such as template selection rules and parameter thresholds, to emphasize highly weighted topics in future prompt sentences. The server outputs refined characteristic information and updated generation conditions that will influence subsequent executions of Steps 7 through 11.

### Step 18

The server optionally performs batched optimization across multiple users. The server, as input, collects updated characteristic information and feedback statistics for a plurality of users. The server applies a numerical optimization procedure, such as a matrix operation across user-feature weight matrices, to adjust global parameters that control feature selection and prompt template assignment. The server may cluster users by similarity of topic distributions and adapt generation conditions per cluster. The server outputs updated global parameters and cluster assignments, which improve computational efficiency and personalization quality across the system in future executions of the processing flow.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional recommendation systems typically rely on fixed rule-based engines or statistical models that operate directly on structured data such as user behavior logs, inventory records, and promotion records. In such systems, a server often performs separate and fragmented processing steps: logging user actions, matching them to predefined product categories, and applying static filters or scoring functions. This architecture suffers from several technical problems.

First, the server must maintain complex, hand-crafted logic to map diverse behavior signals (for example, browsing sequences, repeated searches, and partial purchase attempts) to meaningful preferences, which leads to rigid software modules that are difficult to scale or adapt when new item attributes or promotion schemes are introduced. As the volume and variety of behavior data grow, the rule sets and scoring functions become increasingly large and inefficient, causing higher processing latency and increased memory usage on the server side.

Second, when attempting to use generative AI models, many conventional systems simply pass raw or minimally processed user data as prompts, without systematically integrating inventory constraints and promotion constraints into a unified natural language representation. As a result, the generative AI model may produce recommendations for items that are out of stock, outside a valid promotion period, or inconsistent with current system constraints. This leads to technically deficient system behavior in which the server must perform extensive post-filtering to correct the output, increasing computational overhead and response time.

Third, existing systems often treat interaction between the recommendation engine and the user as a one-time or loosely coupled process. User reactions to recommendations (for example, clicks on recommended items or ignoring them) are not efficiently fed back into the recommendation pipeline as structured behavior signals for improving subsequent recommendations. This lack of a closed feedback loop prevents effective online adaptation of the recommendation logic and results in inefficiencies in storage structures, indexing, and retrieval of behavior data.

From a computer-technology perspective, these shortcomings manifest as suboptimal utilization of processing resources on the server, redundant query execution against data storage, insufficiently structured construction of prompt sentences for generative AI models, and lack of a systematic mechanism to update internal user preference representations based on reaction data. Consequently, there is a technical need for a system and processing method in which a processor can (i) coherently aggregate user behavior information and organization-held information, (ii) construct well-structured prompt sentences that encode both user preference profiles and candidate item constraints, and (iii) form a closed feedback loop that reuses reaction data to refine subsequent prompts. Such a system should improve the efficiency, accuracy, and consistency of recommendation generation while reducing unnecessary computation and data transfer within the server infrastructure.

The specific processing by the specific processing unit 290 of the data processing device 12 in Application Example 1 is realized by the following means.

The present invention provides a server comprising a processor and a storage unit, the processor being configured to store, in the storage unit, user behavior information and organization-held information including inventory information and sales promotion information; to analyze the user behavior information stored in the storage unit to extract preference information of a user, to select candidate item information including the inventory information and the sales promotion information in accordance with the preference information, and to generate a prompt sentence in a natural language format by integrating the preference information and the candidate item information; to transmit the prompt sentence as input data to a generative AI model and to instruct the generative AI model to generate personalized item recommendation information; to analyze the personalized item recommendation information received from the generative AI model and to convert the personalized item recommendation information into recommendation result data including item identification information and explanation information that are consistent with the candidate item information; to transmit the recommendation result data to a user terminal and to perform communication processing such that the personalized item recommendation information is displayed on the user terminal; and to acquire, from the user terminal, user reaction information to the personalized item recommendation information as additional user behavior information, to store the additional user behavior information in the storage unit, and to reuse the stored additional user behavior information for generation of a subsequent prompt sentence. This enables a technical improvement in computer-based recommendation processing by allowing the server to construct constrained and context-rich prompt sentences that tightly couple user preference profiles with real-time inventory and promotion constraints, to offload complex relevance reasoning to the generative AI model in a controlled manner, and to implement an efficient feedback loop in which reaction data is systematically incorporated into subsequent prompt generation, thereby reducing server-side rule complexity, improving cache and index utilization in data storage, and enhancing responsiveness and accuracy of personalized recommendations.

The term “processor” refers to a hardware-based or virtualized computation unit configured to execute instructions of a program, including a central processing unit, a microprocessor, or a processing core in a computing environment.

The term “storage unit” refers to a hardware-based or virtualized data retention resource, including a memory device or a storage device, configured to store data such as user behavior information and organization-held information.

The term “user behavior information” refers to data representing actions performed by a user in an information processing environment, including at least browsing history information, search history information, and reaction information related to presented content.

The term “organization-held information” refers to data maintained by a commercial or service-providing entity, including at least inventory information and sales promotion information associated with items to be recommended.

The term “inventory information” refers to data indicating availability of items, including at least stock quantity, item identification, and status information for each item managed by an organization.

The term “sales promotion information” refers to data defining promotional conditions for items, including at least discount information, campaign information, and effective period information.

The term “preference information” refers to data representing inferred preferences or interests of a user, derived from user behavior information, and including at least an interest field, a preferred price range, and optionally preferred item attributes.

The term “candidate item information” refers to data representing one or more items that are selectable as recommendation targets, the data including at least item identification information, inventory information, and sales promotion information associated with the items.

The term “prompt sentence” refers to a text sequence in a natural language format constructed from preference information and candidate item information and configured to be supplied as input data to a generative AI model.

The term “generative AI model” refers to a machine-learned model configured to generate natural-language output or other content in response to input data, the model including at least a parameterized neural network trained on example data.

The term “personalized item recommendation information” refers to output data generated by the generative AI model based on a prompt sentence, the output data including at least a set of items and explanatory text tailored to the preference information of a specific user.

The term “recommendation result data” refers to structured data derived from personalized item recommendation information and including at least item identification information, explanation information, and optional ranking or scoring information.

The term “item identification information” refers to data uniquely or distinctively identifying an item within an inventory, including at least an item identifier, a category identifier, or a combination thereof.

The term “explanation information” refers to natural-language text or equivalent descriptive data that explains reasons for recommending an item, including references to user preferences, item attributes, and applicable promotions.

The term “user terminal” refers to an information processing apparatus operated by a user, including at least a personal computer, a mobile device, or an equivalent client device capable of communicating with the server and displaying recommendation result data.

The term “browsing history information” refers to a subset of user behavior information representing access records to information resources, including at least accessed resource identifiers, timestamps, and optionally interaction details such as scroll or click events.

The term “search history information” refers to a subset of user behavior information representing search operations performed by the user, including at least search queries, timestamps, and optionally search filters or parameters.

The term “interest field” refers to a conceptual category or domain of items inferred as being of interest to a user, including for example a product category, service category, or topical area.

The term “price range” refers to a value interval representing preferred or frequently selected price levels of items by a user, inferred from user behavior information or explicitly specified by the user.

The term “user profile information” refers to structured data describing characteristics of a user for recommendation processing, including at least preference information such as interest fields and price ranges, and optionally demographic or contextual attributes.

The term “user reaction information” refers to data representing responses of a user to presented recommendation result data, including at least click actions, selection actions, purchase actions, or ignore actions related to recommended items.

The term “effective period” refers to a time interval during which sales promotion information is valid for an item, the interval being represented by at least a start time and an end time.

The term “stock condition” refers to one or more constraints on inventory information, including at least a required minimum stock quantity, stock status, or availability requirement used to determine whether an item is eligible as a candidate item.

In one embodiment, a server, a user terminal, and a data storage apparatus cooperate to implement the claimed system. The server includes at least one hardware processor such as a central processing unit and a main memory, and executes application software implemented using, for example, an application framework such as a web application framework. The server further accesses a database management system such as a relational database system and a generative AI model implemented as a neural network-based language model. The terminal includes a processor and a display unit, and executes client software such as a web browser or a native application. The user operates the terminal to browse information resources, to issue search queries, and to interact with recommendation results.

The server stores, in a storage unit such as a relational database, user behavior information and organization-held information. The server defines user behavior information by a specific data structure including, for example, a user identifier, a session identifier, a resource identifier such as a uniform resource locator, a search query string, an event type (view, click, add-to-cart, ignore), a timestamp, and optional context attributes such as device type or location category. The server defines organization-held information by tables that include, for each item, item identification information, category information, inventory information including stock quantity and stock status, and sales promotion information including discount rate, campaign identifier, and effective period.

The server uses a database management system such as a structured query language-based system to store and retrieve the user behavior information and the organization-held information. The server defines indexes on frequently accessed columns such as user identifier, item identifier, and timestamp so that the server can perform efficient retrieval, aggregation, and filtering of these data. By structuring the data and the indexes in this way, the server reduces input/output operations on the storage unit and improves processing speed when constructing recommendation-related data.

The server analyzes the user behavior information stored in the storage unit to extract preference information of a user. The server performs this analysis by executing algorithms that operate on time-ordered sequences of behavior events. The server computes, for example, frequency counts of search queries, distributions of clicked item categories, histograms of selected price ranges, and dwell time statistics on item detail pages. The server aggregates these statistics into a user profile structure that includes an interest field, a preferred price range, and optional preferred attributes such as cushioning level for shoes, brand categories, or size ranges. The server may represent this user profile as a vector or as a structured record and may update it incrementally as new behavior information arrives.

The server selects candidate item information based on the preference information and the organization-held information. The server retrieves inventory records matching the interest field and price range in the user profile from the storage unit by executing structured queries. The server filters out items that do not satisfy stock conditions, such as items with zero stock quantity or items whose sales promotion effective period has expired. The server may compute a preliminary relevance score for each candidate item using non-generative algorithms, such as a weighted sum of category match, price proximity, and past click-through rate. The server then selects a subset of items that exceed a threshold relevance score and defines them as candidate item information.

The server generates a prompt sentence in a natural language format by integrating the preference information and the candidate item information. The server uses a string construction module that takes the user profile and the candidate item list as inputs and outputs a text block. The server structures the prompt sentence so that sections of the text correspond to (i) a role or task description for the generative AI model, (ii) a summary of the user behavior, (iii) an explicit enumeration of candidate items with their attributes, and (iv) a specific instruction describing what type of personalized item recommendation information should be generated.

For example, the server can generate a prompt sentence as follows:

You are a generative AI model acting as a product recommendation assistant.

### User Behavior Summary

The user has recently searched for “running shoes” three times in the last week.
The user prefers beginner-level running shoes with good cushioning.
The user usually chooses products priced between $70 and $90.

Candidate products from current inventory:
1. Product A: Beginner running shoes, price $80, strong cushioning, in stock, 10% off as part of the “Spring Running Fair”.
2. Product B: Lightweight running shoes, price $75, moderate cushioning, in stock, 10% off as part of the same campaign.
3. Product C: Stability running shoes, price $90, designed for mild overpronation, in stock, no discount.

### Task

Based on the user's behavior summary and the candidate products above, generate a personalized recommendation message in English.

Recommend the most suitable products, explain briefly why each product matches the user's needs, and mention any active promotions when relevant.

In another example, the server can generate a prompt sentence that emphasizes history and budgets:

You are an AI assistant that generates product recommendations.

### User's Behavior History

The user has recently searched for “running shoes”, “beginner running shoes”, and “cushioning running shoes”.
The user often clicks products priced between $60 and $100.
The user rarely clicks on competition-oriented or very high-end models.

### Task

Using only this behavior history, generate a ranked list of three types of running shoes that the user is likely to buy.

For each type, provide:
a short name,
a target user description,
and a brief reason why it matches this user.

The server transmits the prompt sentence to a generative AI model via an application programming interface. The generative AI model is implemented as a neural network with a transformer architecture, having an embedding layer, a stack of multi-head self-attention layers, feed-forward layers, and an output softmax layer. The model parameters are stored in a model storage and are loaded into a model execution engine. The server sends the prompt sentence as a sequence of tokens, where the model transforms tokens into vector representations, computes attention weights, and produces probability distributions over output tokens in an autoregressive manner.

The server uses model parameters that have been trained in advance by minimizing a loss function, such as a cross-entropy loss, over a large corpus of natural language text. During training, a training processor updates model weights using an optimization algorithm such as stochastic gradient descent or an adaptive method. The generative AI model thereby learns internal representations of language and relationships between user preference descriptions and item attributes. In some embodiments, the server further fine-tunes the generative AI model on domain-specific data that includes annotated recommendation dialogues, where the loss function may incorporate penalties for recommending out-of-stock items or items outside a valid promotion period.

The server configures the generative AI model invocation with parameters such as a maximum token count for the output, a temperature parameter controlling randomness, and optional constraints on output length or structure. By carefully constructing the prompt sentence and configuring these parameters, the server ensures that the generative AI model generates personalized item recommendation information that is both consistent with the candidate item constraints and rich in explanatory text. This approach is different from simple automation of human recommendation because the server uses a non-standard, machine-optimized natural-language encoding of structured constraints, thus enabling the model to perform higher-order reasoning over a constrained item set.

The server receives the personalized item recommendation information as a generated text sequence. The server parses this text using pattern matching or light-weight natural language processing to identify item references, such as product names or identifiers, and to extract explanation segments corresponding to each recommended item. The server cross-checks these item references against the candidate item information in the storage unit to ensure consistency and to prevent the use of out-of-stock items. If the generative AI model outputs an item that is not part of the candidate list, the server either rejects that part of the output or replaces the item by a closest matching candidate item as determined by a similarity function defined over item attributes.

The server converts the personalized item recommendation information into recommendation result data with a defined structure, including item identification information, explanation information, and optional ranking scores. The server stores or caches this structured data in a memory area optimized for fast access by the communication module. The server then transmits the recommendation result data to the terminal as a structured response using a communication protocol such as HTTP over a secure transport.

The terminal receives the recommendation result data and renders it into user interface elements such as lists, cards, or banners, displaying item images, names, prices, discounts, and the explanation information. The user views these recommendation results and may interact by clicking on a recommended item, adding it to a shopping cart, or closing the recommendation view. The terminal records such user reactions as user reaction information, including an identifier of the recommendation session, an identifier of the item clicked or ignored, and a timestamp.

The terminal sends the user reaction information back to the server. The server stores the user reaction information in the storage unit as part of the user behavior information. The server updates the user profile with these new signals, for example by increasing the weight of attributes associated with clicked items and decreasing the weight of attributes associated with ignored items. The server thereby refines the preference information and uses this refined preference information during generation of subsequent prompt sentences. This closed-loop mechanism allows the server to adapt recommendation behavior over time and to improve both response relevance and efficiency.

From a technical perspective, this configuration improves computer technology in multiple ways. Because the server integrates inventory constraints, promotion constraints, and user preference profiles into a single prompt sentence, the generative AI model operates on a compact, information-rich representation. The server consequently reduces the need for extensive post-processing filters and redundant database queries. The server's data structures and indexes for behavior information and organization-held information reduce search time when constructing prompts and checking generated outputs, thereby improving processing speed.

The server reduces communication load by transmitting to the generative AI model only those candidate item attributes that are relevant under the current constraints, rather than the entire inventory. Furthermore, by using a specialized user profile representation and non-conventional prompt construction rules, the server offloads part of the combinatorial reasoning from server-side rule engines to the generative AI model, resulting in simplified code paths within the server and reduced maintenance of hand-crafted rules.

The server implements a non-standard processing flow in which user reaction information is not merely logged but is structured and incorporated into the next prompt sentence. This enables the generative AI model to see explicit descriptions such as:

The user previously ignored high-end competition shoes and clicked multiple beginner models around $80. Focus on mid-range beginner shoes rather than premium racing shoes.

Such text encodes reaction patterns in a manner that the model can interpret directly, without manually crafted rules. As a result, the system decreases misaligned recommendations and reduces the need for repeated trial-and-error interactions, which in turn decreases server load and shortens end-to-end latency.

The server can implement alternative embodiments. In one embodiment, the server uses a different type of database, such as a document-oriented database, but still defines indices and schemas such that retrieval of user behavior information and organization-held information is efficient. In another embodiment, the server uses a different generative AI model architecture, such as a recurrent neural network or a hybrid architecture combining convolutional and attention layers, provided that the model accepts a prompt sentence and outputs natural-language recommendations. In a further embodiment, the server modifies the loss function used during fine-tuning to directly penalize output tokens that correspond to items failing stock conditions, thereby embedding system constraints more deeply into the model behavior.

In yet another embodiment, the server runs a pre-processing module that computes numeric feature vectors for each candidate item, including normalized price, attribute encodings, and promotion flags, and uses these vectors to determine the order and grouping of items in the prompt sentence. By ordering items based on feature proximity to the user profile before passing them to the generative AI model, the server biases the model toward more relevant outputs and simultaneously reduces the search space. This ordering operation is a specific algorithmic step that goes beyond simple data listing and results in quantifiable improvements in recommendation precision and processing time.

Through these embodiments, the server, the terminal, and the user cooperate in a way that is tightly bound to the technical characteristics of the computing environment. The system is not a mere automation of human recommendation, but a specific arrangement of data structures, neural network architecture, prompt sentence encoding, and feedback processing that improves the speed, accuracy, and efficiency of computer-based recommendation processing.

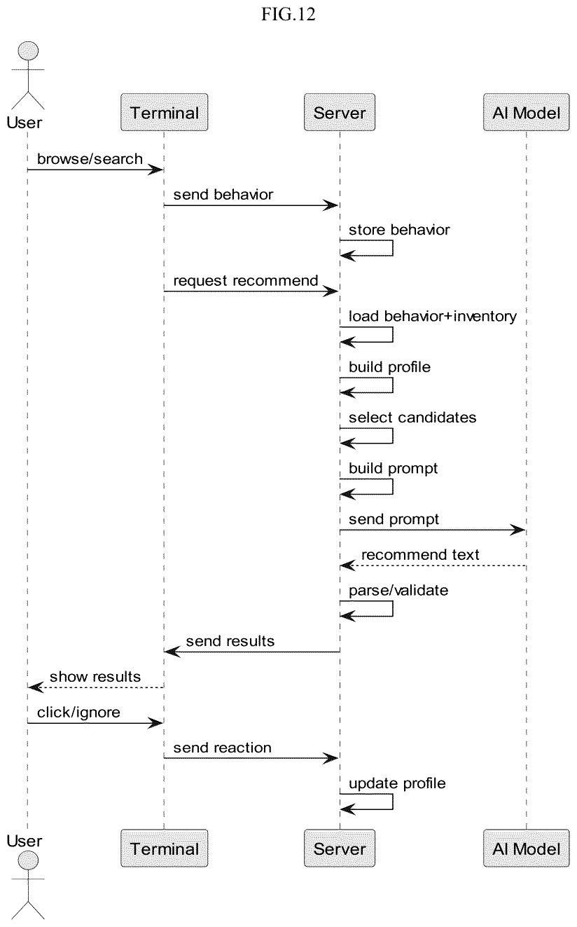

The following describes the processing flow using FIG. 12.

### Step 1

The terminal displays an information resource such as a product list page or search page using a browser or native application.

The user views the displayed content and performs operations such as entering a search query, scrolling, clicking an item, or adding an item to a cart.

Input: user actions on the terminal (keystrokes, taps, clicks, scrolls).

The terminal converts these actions into structured user behavior information including at least a user identifier, a session identifier, a resource identifier, a query string, an event type, and a timestamp.

Output: structured behavior records stored temporarily in the terminal's memory.

### Step 2

The terminal sends the structured user behavior information to the server using a network protocol such as HTTPS.

Input: behavior records generated in Step 1.

The terminal encapsulates the behavior records in a request payload (for example, JSON) and transmits the payload to an endpoint exposed by the server.

Output: a network message delivered to the server containing the behavior records.

### Step 3

The server receives the network message from the terminal and parses the payload.

Input: the request payload including user behavior information.

The server validates data types, checks required fields such as user identifier and timestamp, and discards malformed entries. The server then converts the payload fields into internal objects compatible with a database schema.

Output: sanitized and normalized behavior objects ready for persistence.

### Step 4

The server stores the sanitized and normalized behavior objects in a storage unit such as a relational database.

Input: internal behavior objects from Step 3.

The server executes database insertion operations to write the behavior objects into tables such as a user_behavior table, and updates indices on columns such as user identifier and timestamp. These database operations transform transient memory objects into persistent, queryable records.

Output: persistent user behavior information stored in the storage unit.

### Step 5

The server periodically or on demand loads organization-held information including inventory information and sales promotion information from the storage unit into memory.

Input: stored inventory records and promotion records in the database.

The server executes query operations to retrieve item identifiers, categories, stock quantities, prices, and promotion parameters such as discount rate and effective period. The server then constructs in-memory data structures such as maps or lists indexed by item identifier.

Output: cached organization-held information in memory for fast access.

### Step 6

The server receives a recommendation request from the terminal when the terminal displays or is about to display a page where recommendations are needed.

Input: a request message including at least a user identifier and current context (for example, category or page type).

The server parses the request, verifies the user identifier, and associates the request with a session. The server then prepares to retrieve corresponding behavior and organization data.

Output: an internal recommendation context containing the user identifier and page context.

### Step 7

The server retrieves stored user behavior information associated with the user identifier from the storage unit.

Input: the user identifier and context from Step 6.

The server runs database queries to obtain recent events such as search queries, viewed categories, clicked items, and reactions to previous recommendations. The server filters the events by a time window and by relevance to the current context.

Output: a set of filtered behavior records for the current user and context.

### Step 8

The server aggregates the filtered behavior records to derive preference information.

Input: the set of filtered behavior records from Step 7.

The server counts frequencies of search queries, computes distributions of clicked item categories, calculates minimum and maximum prices of frequently selected items, and derives indicators such as ignored premium items or repeatedly viewed entry-level items. The server combines these statistics to form a user profile that includes an interest field, a preferred price range, and attribute preferences.

Output: structured preference information representing the user profile.

### Step 9

The server selects candidate item information by matching the preference information with the cached organization-held information.

Input: preference information from Step 8 and cached inventory and promotion data from Step 5.

The server filters items whose category matches the interest field and whose price lies within or near the preferred price range. The server discards items that fail stock conditions or whose promotion effective period has expired. The server may compute a preliminary relevance score for each remaining item and keeps only items whose scores exceed a threshold.

Output: a list of candidate item records each containing item identification information, inventory information, and promotion information.

### Step 10

The server orders and formats the candidate item list for prompt construction.

Input: the candidate item records from Step 9.

The server sorts the candidates according to relevance scores or specific attributes (for example, beginner level first, then advanced level). The server limits the list length to a predetermined maximum to control prompt size, and extracts key attributes such as name, price, main features, stock status, and promotion details.

Output: an ordered and truncated candidate item list prepared for inclusion in a prompt sentence.

### Step 11

The server constructs a prompt sentence to be supplied to the generative AI model.

Input: the preference information from Step 8 and the ordered candidate item list from Step 10.

The server assembles a text block composed of sections: a role description for the generative AI model, a user behavior summary, an explicit enumeration of candidate items with attributes, and a task description. The server uses string concatenation and template filling to convert structured data into natural-language sentences.

Output: a prompt sentence in natural language format encoding both user preferences and candidate item constraints.

### Step 12

The server configures parameters for invocation of the generative AI model.

Input: the prompt sentence from Step 11 and system-level constraints such as maximum output length.

The server sets model parameters including maximum output tokens, temperature, and optional guidance prompts. The server may adjust these parameters based on the number of candidate items or complexity of the user profile.

Output: a model invocation configuration including the prompt sentence and parameter values.

### Step 13

The server transmits the prompt sentence and the configuration to the generative AI model through an application programming interface.

Input: the model invocation configuration from Step 12.

The server encodes the prompt sentence as a sequence of tokens, packages the tokens and parameters in an API request, and sends the request to a model execution endpoint. This operation transforms high-level text into token-level data suitable for neural network computation.

Output: a request accepted by the generative AI model for processing.

### Step 14

The generative AI model processes the prompt sentence to generate personalized item recommendation information, and the server receives the generated output.

Input: the tokenized prompt and parameters from Step 13.

The model applies a sequence of neural network operations such as embedding lookups, multi-head attention, and feed-forward transformations to compute probabilities for output tokens. The server receives the generated text as a token sequence and decodes it into a natural-language string.

Output: raw personalized recommendation text containing item mentions and explanations.

### Step 15

The server parses the personalized recommendation text to extract structured information.

Input: the raw recommendation text from Step 14 and the candidate item list from Step 10.

The server uses pattern matching, keyword detection, and mapping of product names to item identifiers to identify which candidate items are mentioned in the text. The server segments the text into explanation parts corresponding to each mentioned item.

Output: intermediate structured data mapping item identifiers to generated explanation sentences.

### Step 16

The server validates the extracted item references against the candidate item information and organization-held information.

Input: the intermediate structured data from Step 15 and the stored candidate item information from Step 9.

The server checks that each mentioned item identifier is still present in the candidate list and still satisfies stock and promotion constraints. If an inconsistency is detected, the server removes the invalid recommendation or replaces it with a valid candidate selected according to a similarity metric over item attributes.

Output: a cleaned set of recommended items with consistent explanations.

### Step 17

The server constructs recommendation result data for transmission to the terminal.

Input: the cleaned set of recommended items and explanations from Step 16.

The server arranges the items into a structured format including item identification information, prices, image references, promotion labels, and the explanation sentences. The server optionally adds ranking scores or tags to indicate recommendation strength.

Output: structured recommendation result data ready for delivery.

### Step 18

The server sends the recommendation result data to the terminal using a communication protocol.

Input: the structured recommendation result data from Step 17.

The server serializes the data into a response message and transmits the message to the terminal over a network.

Output: a response received at the terminal containing the recommendation result data.

### Step 19

The terminal receives the recommendation result data and renders it in the user interface.

Input: the response message containing the recommendation result data from Step 18.

The terminal parses the data, creates user interface components such as product tiles and explanation text areas, and displays the personalized recommendations on the screen.

Output: a visual representation of recommended items accessible to the user.

### Step 20

The user interacts with the displayed recommendations.

Input: the rendered recommendation interface from Step 19.

The user performs actions such as clicking an item, scrolling through the list, adding an item to a cart, or ignoring the recommendations. These interactions constitute new behavior events.

Output: raw user interaction events at the terminal.

### Step 21

The terminal records the user interaction events as user reaction information.

Input: the raw user interactions from Step 20.

The terminal maps clicks, selections, and dismissals into structured reaction records including the recommendation session identifier, the item identifier, an action type, and a timestamp.

Output: structured user reaction information stored on the terminal.

### Step 22

The terminal sends the user reaction information to the server.

Input: the structured reaction information from Step 21.

The terminal encapsulates the reaction records into a network request and transmits the request to the server using the same communication channel as behavior information.

Output: a reaction information payload received by the server.

### Step 23

The server stores the user reaction information and updates the user profile.

Input: the reaction information payload from Step 22 and the existing user profile from Step 8.

The server writes the reaction records to the behavior tables, then recalculates or incrementally updates preference statistics. For example, the server increases the weight of attributes associated with clicked items and decreases the weight of attributes associated with ignored items. This computation adjusts distributions and feature values in the user profile.

Output: an updated preference information set that reflects both historical behavior and reactions to prior recommendations.

### Step 24

The server uses the updated preference information when constructing the next prompt sentence for the generative AI model.

Input: the updated preference information from Step 23.

The server modifies the user behavior summary portion of the prompt to include statements about recent reactions, and may adjust the selection and ordering of candidate items accordingly. This data transformation ensures that future prompt sentences capture evolving user tendencies.

Output: a refined basis for subsequent prompt sentence generation that improves future recommendation accuracy and efficiency.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

In conventional electronic commerce systems, recommendation engines typically rely on predefined rules or static statistical models that operate on coarse-grained user attributes and simple behavior logs. These systems often process user behavior data and catalog data in separate subsystems, with limited integration of real-time interaction signals and promotion information. As a result, several technical problems arise in the underlying computer technology.

First, existing systems frequently transmit large volumes of raw user behavior data or partially processed logs between a user terminal and a server without structurally integrating such data with item information and sales policy information at the server side. This leads to inefficient utilization of storage resources and communication bandwidth, as similar or redundant data must be repeatedly retrieved, filtered, and joined in multiple application layers. Furthermore, absence of a standardized integrated data structure makes it difficult to optimize database access patterns, which can result in increased query latency and degraded responsiveness of the overall system.

Second, conventional systems that attempt to incorporate generative artificial intelligence models into recommendation workflows often perform ad hoc prompt generation on the application server, without a defined procedure for constructing prompts from well-organized feature values derived from behavior logs, catalog data, and promotion data. In such systems, prompt sentences are manually crafted or built using loosely coupled templates, causing inconsistent utilization of user behavior context and catalog information. This lack of structured prompt generation limits the ability of the underlying computing system to leverage the full expressive capacity of a generative model, and can increase computational overhead due to repeated, non-optimized data preparation steps.

Third, existing systems typically do not implement a closed-loop control mechanism that feeds back fine-grained user reactions to generated recommendations (such as viewing and selection actions on generated content) into a structured update of the integrated data set used for subsequent prompt generation. Instead, user interactions with recommended content are logged in isolation, if at all, and are not immediately applied to refine the data structure that the server uses to build new prompts. This results in a suboptimal use of processing cycles and memory, because the server must repeatedly re-aggregate historical data from scratch rather than incrementally updating feature values, which in turn causes increased latency, higher load on database resources, and reduced scalability.

Accordingly, there is a need for an improved computer-implemented system and method that (i) structurally integrates user behavior information, item information, and sales policy information into an integrated data set optimized for downstream processing, (ii) systematically generates prompt sentences for a generative information processing model based on computed feature values, and (iii) establishes a closed-loop mechanism in which user interactions with generated useful information are used to update the integrated data set and regenerate prompts in a more efficient and responsive manner. The technical problem to be solved by the present invention is to improve the efficiency, scalability, and responsiveness of server-side processing for personalized information generation by coordinating database operations, prompt generation, and generative model invocation in a unified architecture.

The specific processing by the specific processing unit 290 of the data processing device 12 in Example 2 is realized by the following means.

The present invention provides a server comprising a processor and a storage device, the processor being configured to store, in the storage device, behavior information transmitted from a user terminal together with pre-stored item information and sales policy information, to integrate the behavior information, the item information, and the sales policy information into an integrated data set by using a database management function, to calculate feature values for each user based on aggregated viewing categories, viewing counts, dwelling times, price ranges, and purchase histories over a predetermined period, to generate a prompt sentence for a generative information processing model by embedding the feature values and the integrated data set into a predetermined template, to transmit the prompt sentence to the generative information processing model via a communication network and receive useful information generated by the generative information processing model in response to the prompt sentence, to analyze text of the useful information to extract recommended categories, candidate item identifiers, and discount information, and to generate display control data for the user terminal by associating the extracted recommended information and sales policy information with corresponding display regions on the user terminal, while further controlling repeated execution of updating the integrated data set and regenerating the prompt sentence based on additional behavior information regarding viewing or selection of the useful information on the user terminal. This enables an improvement of the underlying computer technology by reducing redundant data processing and data transfer, optimizing database access patterns through integrated and feature-based data structures, and establishing a closed-loop, low-latency interaction between user behavior logging, prompt generation, and generative model output, thereby enhancing the efficiency, scalability, and responsiveness of personalized information delivery in a networked information processing environment.

The term “system” refers to a combination of one or more computing devices, including at least a server and one or more user terminals, interconnected via a communication network and configured to execute coordinated processing operations as described in the claims.

The term “processor” refers to one or more hardware processing units, such as a central processing unit or a processing core, capable of executing instructions to perform arithmetic, logical, control, and input/output operations.

The term “storage device” refers to any non-transitory computer-readable medium, such as a magnetic disk, semiconductor memory, or optical disk, configured to store data and programs for access by the processor.

The term “information processing apparatus” refers to a computing device, including at least a processor and a storage device, that executes software to perform data processing operations and to communicate with external devices or systems.

The term “input/output device” refers to a hardware component or combination of components, such as a display, keyboard, pointing device, or touch panel, that enables input from a user and output of information to the user.

The term “user terminal” refers to an end-user device, such as a personal computer, smartphone, or tablet, that includes an information processing apparatus and an input/output device and that communicates with a server via a communication network.

The term “server” refers to an information processing apparatus or a group of apparatuses that provide data storage, data processing, and service functions to one or more user terminals over a communication network.

The term “communication network” refers to any wired or wireless network, such as a local area network, wide area network, or packet-switched public network, that enables data transmission between a server and a user terminal.

The term “behavior information” refers to data indicating operations performed by a user on a user terminal, including at least viewing actions, selection actions, search actions, and other interaction events with content presented on the user terminal.

The term “item information” refers to data describing items handled in an electronic catalog, including at least identifiers, names, categories, prices, availability states, and attribute information of the items.

The term “sales policy information” refers to data indicating marketing or sales conditions associated with items, including at least discount conditions, campaign rules, bundled sale conditions, and validity periods.

The term “integrated data set” refers to a data structure generated by combining behavior information, item information, and sales policy information in a correlated form suitable for subsequent processing by a processor or an external model.

The term “database management function” refers to software functionality for storing, retrieving, updating, and managing structured data, including functions for executing queries, joins, aggregations, and indexing in a database.

The term “aggregation” refers to a process of computing summary values, such as counts, sums, averages, maxima, or minima, over multiple records of behavior information or related data.

The term “feature value” refers to a numerical or symbolic value derived from raw data, such as behavior information, item information, or sales policy information, and used to represent a characteristic of a user, an item, or a context in a compact form.

The term “prompt sentence” refers to a text sequence or text block that encodes instructions, contextual information, and data for input to a generative information processing model to control generation of output information.

The term “template processing function” refers to software functionality that generates a structured text, including a prompt sentence, by inserting data values or feature values into predefined placeholders within a template.

The term “generative information processing model” refers to a machine-implemented model, such as a neural network model, configured to generate output data, including at least natural language text, based on input data and learned parameters.

The term “natural language processing functionality” refers to capabilities of a model or software to analyze, interpret, and generate human language text based on input information.

The term “useful information” refers to information generated by a generative information processing model that is tailored to a user, including at least recommendations, explanations, or alerts that are expected to be relevant to the user.

The term “display data” refers to data formatted for presentation on a user terminal, including layout information and content information that can be processed by a display controller or a rendering engine.

The term “display control data” refers to structured data that associates content, such as useful information, with specific display regions or components on a user terminal to control how the content is presented.

The term “viewing category” refers to a classification of content or items viewed by a user, determined based on item information such as item category or type.

The term “viewing count” refers to a numerical value indicating how many times a user has viewed content or items associated with a particular category or identifier within a predetermined period.

The term “dwelling time” refers to a time duration that a user remains viewing a particular content or item on a user terminal, measured between at least a display start time and a display end time.

The term “price range” refers to a range of monetary values derived from prices of items with which a user has interacted, such as items viewed or purchased, within a predetermined period.

The term “purchase history” refers to data indicating items that have been purchased by a user, including at least item identifiers, purchase times, and purchase prices.

The term “category of interest” refers to a classification inferred from feature values, indicating a category of items or content for which a user exhibits a relatively high level of interaction or preference.

The term “preferred price range” refers to a range of prices inferred from feature values, indicating a price level at which a user has a tendency to view or purchase items.

The term “focused viewed item” refers to an item that is identified, based on behavior information or feature values, as having attracted relatively high attention from a user, for example by repeated views or long dwelling time.

The term “recommended category” refers to a category of items identified from useful information generated by a generative information processing model as being suitable for recommendation to a user.

The term “candidate item identifier” refers to a value that uniquely identifies an item selected or suggested for recommendation within useful information generated by a generative information processing model.

The term “discount information” refers to data indicating a reduction of price or a preferential condition applicable to an item or a group of items, including at least discount rates, discount amounts, and applicable conditions.

The term “recommendation display region” refers to a predetermined area on a user interface of a user terminal in which recommended items or related information are displayed.

The term “sales information display region” refers to a predetermined area on a user interface of a user terminal in which sales policy information, such as discounts or campaigns, is displayed.

The term “real time or quasi-real time” refers to a response characteristic in which useful information is presented to a user terminal with a latency sufficiently small that the information reflects current or recent behavior information during an ongoing user session.

In one embodiment, a server cooperates with one or more terminals operated by users to implement a personalized information generation system. The server includes at least one processor, a main memory, a non-transitory storage device, and a network interface. The processor executes an operating system and an application program that performs data collection, data integration, prompt sentence construction, invocation of a generative AI model, and generation of display control data. The storage device stores behavior information, item information, sales policy information, and configuration data defining templates for prompt sentences and display layouts.

A terminal includes at least one processor, a memory, a display device, a user input device such as a touch panel or pointing device, and a communication interface. The terminal executes a browser or dedicated application. The terminal acquires behavior information by monitoring operations of a user, such as selection of items, execution of search queries, scrolling actions, and activation of buttons, and then transmits behavior information to the server. The terminal receives display control data from the server and renders useful information in predetermined regions on the display device.

A user operates the terminal to browse item information provided by the server, to view recommended content, and to select or ignore items proposed in useful information. The user's operations are not used merely as business transactions, but as signals that update specific data structures and feature values in the server so that subsequent processing steps can be executed with improved computational efficiency and accuracy.

The server executes an application program that organizes data into structured database tables and in-memory feature vectors. For example, the server stores behavior information in a user event table that includes fields for user identifier, event type, item identifier, category identifier, timestamp, dwelling time, and session identifier. The server stores item information in a catalog table that includes fields for item identifier, category, price, stock quantity, and attribute codes. The server stores sales policy information in a promotion table that includes promotion identifier, applicable categories, discount rates, bundles, and validity intervals. The server uses a relational database management system to index these tables on user identifier, item identifier, category, and timestamp, enabling the processor to perform joins and aggregations with reduced latency.

The server generates integrated data sets by executing queries that join the user event table with the catalog table and the promotion table. For example, the server aggregates all events for a particular user over a recent time window and calculates feature values such as viewing counts per category, average dwelling time per category, distribution of viewed prices, and counts of purchased items. The server stores such feature values as elements of a feature vector associated with each user. The server then uses these feature vectors to control how data is formatted into prompt sentences for a generative AI model. By centralizing these operations in well-designed data structures, the server reduces redundant computation and minimizes memory transfers between application layers.

The server implements a template processing function that converts integrated data sets and feature vectors into natural language prompt sentences. For example, the server constructs a prompt sentence by filling in placeholders corresponding to recent categories, representative items, promotions, and inferred user preferences. The following is one example of a prompt sentence:

“Based on the following user behavior and item data, act as a shopping recommendation assistant.

### User Behavior

Last searched category: smartphone case
Recently viewed products:
   1) Product ID 12345: smartphone case, silicone, for model A
   2) Product ID 67890: smartphone case, clear, for model A

### Aggregated Interests

Most frequently viewed category: smartphone accessories
Preferred price range: 20 to 40 units of currency

Related items: screen protectors, wireless chargers, data cables.

### Active Promotions

10% off when buying two or more accessories
Free shipping over a total of 50 units of currency

Please generate personalized recommendations and briefly explain why each item is suitable for this user. Keep the text concise and suitable for an online shopping page.”

The server then transmits the generated prompt sentence to a generative AI model. In one embodiment, the generative AI model is an encoder-decoder neural network or a transformer-based neural network deployed on a remote computing platform and accessed via a network API. The model includes multiple layers of self-attention modules, feed-forward layers, and layer normalization modules. The model has parameters such as token embedding matrices, attention weight matrices, and feed-forward network weights that have been trained in advance using a large corpus of natural language text and domain-specific data.

The server formats the prompt sentence into tokens using a tokenizer consistent with the generative AI model. The server encodes the feature values derived from behavior information and item information into structured natural language segments so that the model can utilize these signals in its attention mechanisms. The generative AI model processes the tokens through multiple attention layers, computing attention scores between tokens representing user behavior, item descriptions, and promotions. The attention mechanism causes the model to prioritize tokens that represent categories with higher viewing counts or longer dwelling times, thereby improving the relevance of generated useful information.

The generative AI model applies a probability distribution over a vocabulary at each output position. The model computes a loss function, such as cross-entropy, during training to adjust its weights via gradient descent. During inference in this system, the model uses the learned parameters to generate output tokens without updating weights. The server controls generation behavior by specifying parameters such as maximum output length and sampling temperature. The server thereby influences whether the generative AI model generates concise or more elaborate recommendations.

The server receives the output tokens from the generative AI model and reconstructs them into a text string representing useful information. For example, the useful information may have the following form:

“Recommended for you:
Tempered glass screen protector for your smartphone, which helps protect the display and complements your recent case selection.
Wireless charging pad compatible with your current device, allowing convenient charging on your desk.
Data cable with high-speed transfer, suitable for frequent backup and synchronization.

### Current Offers

If you purchase any two accessories together, you receive a 10% discount on both items.
When your total exceeds 50 units of currency, shipping fees are waived.”

The server then parses this text string and extracts entities corresponding to categories, item identifiers, and discount descriptions. In one embodiment, the server uses rule-based parsers and pattern matching to split the text into segments for recommendations and segments for promotions. The server maps extracted item names or identifiers to entries in the catalog table, and maps extracted promotion descriptions to entries in the promotion table. This structured extraction allows the server to generate display control data that binds particular recommended items to specific layout regions on the terminal's user interface.

The terminal renders these layout regions using a structured user interface definition. For example, the terminal displays a “Recommendation” region containing item images, names, prices, and short generated descriptions, and displays a “Promotion” region containing the associated discounts and conditions. By associating content with specific regions, the server and terminal reduce the amount of data that must be transferred and rendered; only identifiers and concise text segments are transmitted, while images and static layout parameters are cached at the terminal.

The server uses a closed-loop control mechanism in which additional behavior information arising from the user's interactions with useful information is captured and fed back into the integrated data set. For example, when the user clicks on a recommended item or scrolls through a recommendation list, the terminal records an event containing the item identifier, the region of the interface, and the dwell time. The terminal transmits this event to the server. The server inserts the event into the user event table and updates aggregate features incrementally, rather than recomputing them from all historical data. The server, for instance, updates a counter for “interactions with AI-recommended items” and adjusts the feature values representing categories of interest.

This incremental update reduces the computational cost of subsequent data processing, improving both the latency of generating new prompt sentences and the scalability for concurrent users. The server also reduces communication overhead by transmitting only derived feature updates and compact identifiers, instead of repeatedly sending large raw logs or entire histories for each cycle of recommendation generation.

The server thereby improves computer technology in several ways. First, the server reduces processing time by maintaining integrated data sets and feature vectors that are specifically designed to be consumed by the generative AI model. This arrangement avoids repeated complex joins and aggregations for each recommendation request, which would otherwise impose heavy load on the database engine and increase latency. Second, the server reduces memory usage and improves cache behavior by organizing behavior information and item information into normalized tables and compact feature representations. Third, the server optimizes communication between the server and the generative AI model by generating prompt sentences that provide only the most relevant, aggregated features and representative examples, thereby shortening prompts and reducing bandwidth consumption.

The server employs non-conventional processing rules in comparison with simple rule-based recommendation engines. For example, the server computes a weighted interest score for each category by combining viewing counts, dwelling times, and interactions with AI-generated recommendations. The server uses these weighted scores to select a small subset of categories to be included in the prompt sentence. This selection is not based on fixed business rules, but on dynamic features that directly influence the internal attention weights of the generative AI model. As a result, the model's internal computations, which involve matrix multiplications and non-linear activations over feature-rich token sequences, lead to more accurate and context-aware recommendations than a human operator or a simple heuristic system could produce in the same time frame.

The generative AI model used by the server is not a generic black box, but a model whose architecture and training regime are selected to cooperate with the server's data structures. In one embodiment, the model is a transformer network with multiple encoder and decoder layers, multi-head self-attention, and positional encoding. The server encodes feature values such as “preferred price range” and “category of interest” into natural language statements that are placed in specific positions within the prompt sentence. The transformer's positional encoding and attention mechanisms use these positions to align feature tokens with item description tokens, making it easier for the model to learn correlations between user preferences and catalog attributes. Because the server controls this alignment through explicit template design, the system achieves improved generation accuracy and reduces the need for post-processing corrections.

The server can employ various training and fine-tuning methods. For example, the server collects training pairs of integrated data sets and desirable recommendation texts, and uses them to fine-tune the generative AI model by minimizing a cross-entropy loss between expected output tokens and predicted tokens. The server can also perform data augmentation by generating synthetic behavior sequences that simulate different user interest patterns and price preferences. These synthetic sequences improve the robustness of feature-to-text mappings in the model, which leads to more stable performance under diverse user behaviors.

The system includes multiple alternative embodiments. In one variation, the server executes the generative AI model locally on a graphics processing unit or a specialized accelerator instead of relying on a remote platform. In this variation, the server controls memory allocation, batch processing of multiple prompt sentences, and scheduling of matrix computation kernels to reduce latency and improve throughput. In another variation, the server employs a hybrid architecture that combines a generative AI model with a conventional ranking algorithm. The server first uses the generative AI model to generate candidate textual descriptions and candidate item identifiers, and then applies a ranking algorithm that considers server-side constraints such as stock levels and delivery region availability. The server reorders or filters the generated suggestions according to these constraints before generating final display control data.

In yet another embodiment, the server uses different prompt templates depending on terminal type or network conditions. For example, the server uses shorter prompt sentences and requests shorter outputs when the user terminal is connected via a high-latency mobile network, thereby improving responsiveness. When the terminal is connected via a stable high-bandwidth network, the server may use more detailed prompts and permit longer textual outputs. This adaptive behavior is implemented by the server's program that monitors network metrics and selects appropriate template variants.

The system is not limited to an electronic commerce domain. The server can apply the same integrated data set and feature-based prompt design to other information domains, while still achieving technical improvements in data management and computation. For example, the server can apply similar structures to a content platform where items represent articles or videos, and sales policy information represents access rights or subscription conditions. In each case, the server maintains a structured integrated data set, constructs prompt sentences from feature values, and uses a generative AI model to produce useful information in a form that is efficiently rendered by terminals.

By organizing behavior information, item information, and sales policy information into integrated data sets and using these sets to drive a generative AI model through carefully constructed prompt sentences, the server enables computer-implemented processing that goes beyond simple automation of human judgment. The server introduces non-conventional data structures, processing rules, and model interaction patterns that generate concrete technical effects such as reduced processing time, lower communication load, improved cache performance, and higher accuracy of generated recommendations. The terminal, by capturing behavior information and rendering display control data according to specific regions, cooperates with the server to realize a system that is technically optimized for personalized information generation in networked computing environments.

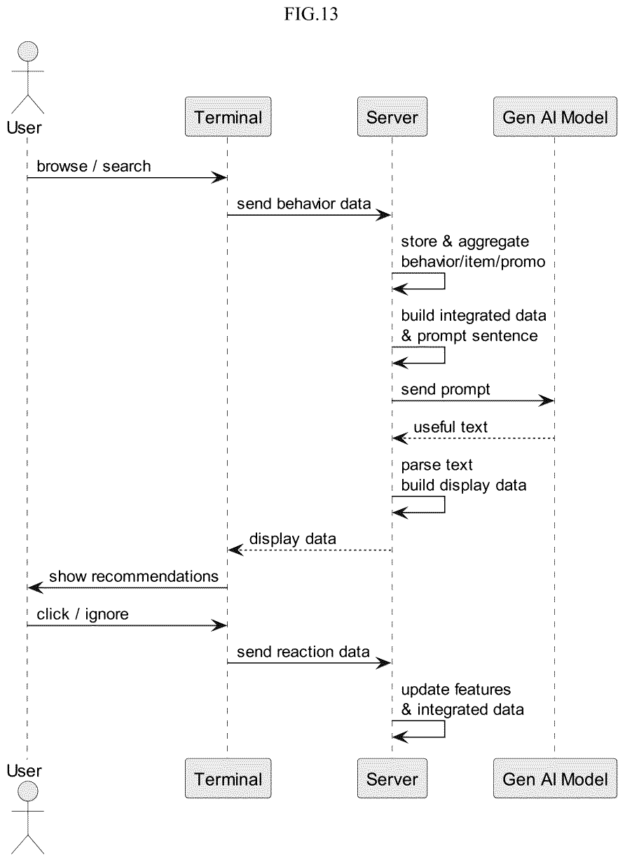

The following describes the processing flow using FIG. 13.

### Step 1

Terminal initializes tracking and user session.

Terminal receives an HTML document or application screen from the server and loads embedded scripts that are configured to monitor user interactions.

Input: markup data and script configuration from the server.

Terminal stores session identifiers in local storage or cookies, initializes event listeners for clicks, scrolls, searches, and item selections, and associates each listener with a handler that records timestamps and element identifiers.

Output: in-memory event records that describe raw user interactions within the current session.

### Step 2

User performs browsing operations on the terminal.

User selects items, enters search queries, scrolls through lists, and views item detail pages.

Input: rendered user interface elements on the terminal's display.

User actions cause the terminal's event listeners to trigger; the terminal captures parameters such as item identifiers, category identifiers, timestamps, and preliminary dwelling times.

Output: updated event records stored temporarily in the terminal's memory, each including user identifier, event type, target element, and time information.

### Step 3

Terminal transmits behavior information to the server.

Terminal packages accumulated event records into a structured request payload and sends the payload to the server via a communication interface.

Input: a collection of raw event records with fields such as user identifier, event type, item identifier, category, and timestamps.

Terminal serializes these records, for example into a structured text or binary format, and transmits them over a network with appropriate headers indicating session context.

Output: behavior information messages received by the server and queued for processing.

### Step 4

Server stores behavior information into persistent storage.

Server receives incoming behavior information messages and validates them.

Input: behavior information messages containing user identifiers, event types, item identifiers, category identifiers, and timestamps.

Server checks formats, filters invalid records, and then executes insertion operations into a behavior log table in a database, assigning sequence numbers and normalizing data where necessary (for example, converting item references into internal item identifiers).

Output: normalized and indexed behavior records stored in the behavior log table, ready for subsequent queries.

### Step 5

Server retrieves and associates item information and sales policy information.

Server queries catalog and promotion tables to obtain context for the logged behavior.

Input: identifiers from the behavior log table, such as item identifiers and category identifiers, and current system time.

Server performs join operations between the behavior log table and the catalog table to obtain item attributes, and between the catalog table and the promotion table to identify applicable promotions based on category and validity period.

Output: intermediate joined records that combine behavior information, item attributes, and applicable sales policies for each relevant interaction.

### Step 6

Server aggregates behavior information into feature values.

Server executes aggregation queries over the joined records to obtain per-user summary statistics.

Input: intermediate joined records containing user identifiers, categories, prices, timestamps, and promotion associations.

Server groups records by user and category, counts views, computes average dwelling times, derives price distributions, and tallies purchases to construct feature values such as viewing count per category, average price of viewed items, and frequency of interactions with promoted items.

Output: feature vectors for each user, stored in a feature table or in memory, where each dimension represents a specific behavior statistic or preference indicator.

### Step 7

Server constructs an integrated data set for prompt generation.

Server combines the feature vectors with representative item information and active promotions.

Input: feature vectors from the feature table, item records from the catalog table, and promotion records from the promotion table.

Server selects a subset of categories and items based on interest scores derived from feature values, and selects promotions relevant to these categories. The server then forms an integrated data set that includes selected categories, items, prices, user preference ranges, and applicable promotions.

Output: an integrated data object that structurally links user preferences, candidate items, and sales policies for prompt creation.

### Step 8

Server generates a prompt sentence for a generative AI model.

Server applies a template to the integrated data set to build a natural language description.

Input: the integrated data object containing selected categories, items, feature values, and promotions.

Server inserts elements such as “last searched category,” “recently viewed items,” “preferred price range,” and “current promotions” into predefined placeholders in a template. The server transforms numerical feature values into human-readable phrases, for example converting a price range into “20 to 40 units of currency.”

Output: a complete prompt sentence, expressed as a text block formatted for input to the generative AI model.

### Step 9

Server sends the prompt sentence to the generative AI model and requests generation.

Server communicates with the generative AI model through a network interface or local model invocation.

Input: the prompt sentence text and generation parameters such as maximum length and sampling temperature.

Server tokenizes the prompt according to the model's vocabulary, encapsulates tokens and parameters in a request, and transmits the request to the model execution environment.

Output: a model inference request that initiates computation of output tokens corresponding to useful information.

### Step 10

Generative AI model generates useful information based on the prompt sentence.

Generative AI model processes the tokenized prompt using its internal neural network architecture.

Input: the sequence of input tokens representing user behavior summary, item descriptions, and promotions.

The model propagates the tokens through multiple layers of attention and feed-forward networks, computes attention scores that highlight tokens corresponding to high interest categories and price ranges, and iteratively predicts output tokens that describe recommended items and applicable promotions. The model uses learned parameters, such as weight matrices and bias vectors, to map the prompt context into a distribution over output tokens.

Output: a sequence of output tokens that, when decoded, form a text string of useful information tailored to the user.

### Step 11

Server receives and decodes the generated useful information.

Server collects the output tokens from the generative AI model and converts them into text.

Input: the sequence of output tokens produced by the model.

Server applies a decoder to map each token back to a corresponding text fragment, concatenates fragments into full sentences, and cleans up spacing and punctuation to obtain a coherent textual description of recommendations and promotions.

Output: a natural language text string describing useful information to be presented to the user.

### Step 12

Server parses the useful information and extracts display elements.

Server analyzes the generated text to identify entities and sections.

Input: the useful information text string produced by the decoding process.

Server applies pattern matching and entity recognition rules to detect item names, category labels, discount phrases, and section headers such as “Recommended for you” or “Current offers.” Server then maps detected item names to internal item identifiers using the catalog table and aligns discount phrases with existing promotion identifiers.

Output: a structured representation of the useful information, divided into recommendation elements and promotion elements associated with specific item identifiers and promotion identifiers.

### Step 13

Server generates display control data for the terminal.

Server formats the structured representation into a layout specification.

Input: structured recommendation elements and promotion elements with associated identifiers.

Server associates each recommendation with a recommendation display region and each promotion with a sales information display region. The server constructs display control data containing region identifiers, item identifiers, textual descriptions, and any flags that indicate emphasis or ordering.

Output: display control data ready for transmission to the terminal, specifying how and where useful information should appear on the terminal screen.

### Step 14

Server transmits display control data to the terminal.

Server sends the formatted layout and content specifications over the network.

Input: the display control data containing region mappings and content details.

Server encapsulates this data in a response message and delivers it via a communication protocol, including metadata such as update timestamps and version identifiers to support caching and efficient updates.

Output: a received display control message at the terminal, which instructs the terminal how to render updated recommendations and promotions.

### Step 15

Terminal renders useful information on the display.

Terminal interprets the received display control data and updates the user interface.

Input: display control data containing target regions, item identifiers, and associated text.

Terminal retrieves any required item images or cached assets based on item identifiers, inserts the generated text into appropriate visual components, and refreshes the recommendation and promotion regions on the display.

Output: a visually updated interface that presents personalized useful information, including recommended items and sales information, to the user.

### Step 16

User interacts with the displayed useful information.

User views, scrolls, or selects recommended items or promotions.

Input: the updated screen containing recommendations and promotions.

User actions cause new events, such as clicks on recommended items or prolonged dwelling over a promotion region. These events are captured by the terminal's tracking scripts, producing new behavior records that reflect reactions specifically to AI-generated content.

Output: additional behavior information focused on interactions with useful information, stored temporarily in the terminal.

### Step 17

Terminal sends reaction behavior information back to the server.

Terminal transmits new events that describe user reactions to the recommendations.

Input: behavior records indicating interactions with specific recommended items and display regions.

Terminal aggregates these reaction events, optionally compresses or filters them, and sends them to the server as part of a subsequent behavior information payload.

Output: updated behavior information messages arriving at the server, including indicators such as “clicked recommended item,” “ignored offer,” or “viewed recommendation for a specified duration.”

### Step 18

Server updates feature values and integrated data sets based on reactions.

Server incorporates reaction information into the existing feature vectors and integrated data structures.

Input: reaction behavior records from the terminal and previously stored feature vectors and integrated data sets.

Server increases counters that track engagement with recommended items, adjusts category interest scores by giving more weight to categories whose recommended items were selected, and decreases scores for categories whose recommendations were ignored. Server then updates the feature table and refreshes or partially recalculates integrated data sets for the affected users.

Output: updated feature vectors and integrated data sets, which encode both historical and reaction-based behavior, ready to be used in constructing improved prompt sentences in subsequent cycles.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional information recommendation systems typically rely on static rule sets, coarse-grained user profiles, or simple collaborative filtering executed by general-purpose processors. Such systems treat user behavior logs as batch data and do not tightly integrate real-time behavior signals, emotional state estimation, and natural-language generation logic within a unified processing pipeline. As a result, a processor must execute multiple loosely coupled components, incurring repeated data transformation, redundant model invocations, and inefficient network round-trips between application logic and external services. This leads to increased processing latency, higher resource consumption, and reduced throughput when handling large volumes of user events.

Furthermore, known systems usually feed limited, preformatted parameters to a language generation engine, without systematically encoding rich behavior features and emotional state information in a structured prompt sentence. The generative model therefore operates on under-specified context, which degrades the quality and relevance of generated outputs. Because feedback signals from user interactions with generated content are not looped back into the prompt construction and feature-generation logic in a fine-grained manner, the system cannot efficiently adapt to changing user interests. These deficiencies result in sub-optimal utilization of computing resources and network resources, as processors repeatedly perform ineffective recommendation computations.

Accordingly, there is a need for a technical mechanism by which a processor can: (i) capture user behavior events in real time from a user terminal; (ii) maintain and update time-series behavior data in storage; (iii) apply machine learning-based feature extraction and interest prediction together with emotion analysis; (iv) construct, in a programmatic and repeatable manner, a prompt sentence that encodes these computed features as context for a generative AI model; and (v) feed back interaction outcomes into subsequent model invocations. By implementing such a mechanism at the processor level, the system can reduce end-to-end latency, improve cache locality and memory access patterns for model execution, and enhance the effectiveness of recommendation processing, thereby improving the overall operation of the computer system itself, rather than merely presenting different content to a human user.

The specific processing by the specific processing unit 290 of the data processing device 12 in Application Example 2 is realized by the following means.

The present invention provides a server comprising a processor, a storage device, and a communication interface, wherein the processor is configured to provide, via the communication interface, an information input and output function for receiving behavior information and request information from a user terminal operated by a user; to store, in the storage device using a data management function, browsing history, search history, and operation history received from the user terminal as time-series behavior data, and to associate and combine the behavior data with information resources held by an information providing entity; to generate, from the combined behavior data and the information resources, feature values and prediction results by using a machine learning model so as to calculate an interest index of the user; to estimate an emotional state of the user by using an emotion analysis function; to construct a prompt sentence for a generative AI model by embedding the interest index, the emotional state, and candidate related information into a textual context; to input the constructed prompt sentence into the generative AI model via the communication interface, to receive output information from the generative AI model, to analyze the output information, and to structure the output information as personalized information including recommendation target items, explanation text, and notification messages; to transmit the structured personalized information to the user terminal in real time by using a message distribution function, an interactive communication function, or a notification management function via the communication interface; and to acquire, from the user terminal, additional behavior data including selection operations, viewing operations, or rejection operations performed by the user with respect to the personalized information, and to update, on the basis of the additional behavior data, the feature value generation and the construction of the prompt sentence so as to continuously improve information generation processing performed by the generative AI model. This enables the server to implement an integrated, closed-loop computation pipeline that reduces redundant data transfers and model calls, optimizes use of processor and memory resources for real-time recommendation, and improves the technical performance and scalability of the computer system when generating and delivering personalized information.

The term “processor” refers to a hardware or virtual processing unit configured to execute instructions of a program, including control logic that performs data acquisition, analysis, model execution, prompt construction, and communication operations in the system.

The term “storage device” refers to a memory component, such as a volatile memory or non-volatile memory, that is configured to store time-series behavior data, information resources, model outputs, and structured personalized information for access by the processor.

The term “communication interface” refers to a hardware or software communication component configured to exchange data between the server and external devices, including user terminals and external services, by using wired or wireless communication protocols.

The term “user terminal” refers to an information processing device operated by a user, such as a computing device or communication device, that is configured to transmit behavior information and request information to the server and to present personalized information to the user.

The term “behavior information” refers to data indicating actions performed by a user through the user terminal, including but not limited to browsing operations, search operations, selection operations, viewing operations, and rejection operations.

The term “request information” refers to information transmitted from the user terminal that explicitly represents a user's demand or query for content or services, including search keywords, filter conditions, or request parameters.

The term “browsing history” refers to a subset of the behavior information indicating records of content that the user has viewed via the user terminal, including identifiers of accessed resources and associated timestamps.

The term “search history” refers to a subset of the behavior information indicating records of search inputs provided by the user, including search queries, filter criteria, and associated timestamps.

The term “operation history” refers to a subset of the behavior information indicating user interface actions other than simple viewing, including clicks, selections, scrolls, additions to a list, purchases, dismissals, and similar operations.

The term “time-series behavior data” refers to behavior information that is stored together with temporal information so that a sequence of user actions can be processed in chronological order.

The term “data management function” refers to a logical function executed by the processor to store, update, retrieve, and organize data in the storage device, including indexing, association, and consistency management of behavior data and information resources.

The term “information providing entity” refers to an organization, service, or system that holds information resources to be used for generating personalized information, such as product data, content data, or knowledge data.

The term “information resources” refers to data sets or records held by the information providing entity, including content data, product data, service data, and metadata, which can be combined with behavior data to generate personalized information.

The term “machine learning model” refers to a computational model trained on data to perform tasks such as classification, regression, or prediction, and configured to generate feature values and prediction results from input behavior data and information resources.

The term “feature values” refers to numerical or categorical representations derived from behavior data and information resources, which encode characteristics such as user interests, usage patterns, or content attributes for input to the machine learning model.

The term “prediction results” refers to outputs of the machine learning model that estimate properties such as user preferences, likelihoods of interest, or relevance scores for certain content or items.

The term “interest index” refers to a quantitative value or set of values computed from the prediction results that indicates a degree or profile of the user's interest with respect to categories, items, or topics.

The term “emotion analysis function” refers to a computational function, implemented by software or a model, that estimates an emotional state of the user based on text information, usage-situation information, or behavior patterns.

The term “emotional state” refers to a condition of the user's affect, such as joy, curiosity, frustration, satisfaction, or other emotional categories, expressed as labels, indices, or scores inferred by the emotion analysis function.

The term “generative AI model” refers to a machine learning model configured to generate new data, including natural-language text, based on an input prompt sentence and context information, by predicting sequences of tokens or other generative outputs.

The term “prompt sentence” refers to a text string or sequence of symbols constructed by the processor to instruct the generative AI model, the prompt sentence encoding context information such as interest indices, emotional states, and candidate related information.

The term “candidate related information” refers to information items or item descriptors selected from the information resources as potential elements of personalized information, including candidate products, content entries, or services.

The term “textual context” refers to a representation of structured or unstructured information in text form, which is embedded in the prompt sentence to provide background information and constraints to the generative AI model.

The term “output information” refers to data generated by the generative AI model in response to the prompt sentence, including at least natural-language text that describes recommendations, explanations, or messages.

The term “personalized information” refers to information that has been structured by the processor from the output information and other data so as to be tailored to an individual user's interests, behavior, and emotional state.

The term “recommendation target items” refers to items such as products, content entries, or services that are selected by the processor from the information resources and designated as subjects of recommendation in the personalized information.

The term “explanation text” refers to a portion of the personalized information that describes reasons, characteristics, or advantages of the recommendation target items, and that is generated or refined using the output information from the generative AI model.

The term “notification messages” refers to message bodies, titles, or summaries prepared for delivery to the user terminal, which inform the user of the personalized information or recommended items.

The term “message distribution function” refers to a logical function executed by the processor to schedule, route, and send messages containing personalized information to the user terminal via the communication interface.

The term “interactive communication function” refers to a communication capability that maintains a bidirectional communication channel between the server and the user terminal, enabling real-time exchange of messages and updates.

The term “notification management function” refers to a function that controls how, when, and to which user terminal notifications containing personalized information are delivered, including rate limiting, prioritization, and targeting.

The term “selection operations” refers to user actions indicating a positive choice with respect to displayed personalized information, such as clicking, tapping, or otherwise selecting recommended items.

The term “viewing operations” refers to user actions that involve viewing or expanding details of the personalized information or recommendation target items, such as opening a detail view or scrolling through a recommendation list.

The term “rejection operations” refers to user actions that indicate a negative response to the personalized information, such as dismissing a notification, closing a recommendation card, or explicitly indicating disinterest.

The term “additional behavior data” refers to behavior information generated after the personalized information is presented, including selection operations, viewing operations, and rejection operations that are used to refine subsequent processing.

The term “update” refers to a process performed by the processor to modify parameters, weights, feature generation rules, or prompt construction templates based on newly acquired behavior data or interaction outcomes.

The term “information generation processing” refers to a processing sequence performed by the processor, including feature value generation, interest and emotion estimation, prompt construction, generative AI model invocation, and structuring of output information into personalized information.

Server provides a concrete hardware and software platform for implementing the claimed system. Server includes at least one general-purpose processor, a main memory, a non-volatile storage device, and a network interface. Server executes an operating system such as a generic server operating system, and executes application software implemented, for example, in a general-purpose programming language. The application software includes modules corresponding to an event ingestion module, a data management module, a feature extraction module, a prediction module, an emotion analysis integration module, a prompt construction module, a generative AI integration module, a response structuring module, and a notification management module.

Terminal is an information processing device such as a smartphone, tablet, or personal computer. Terminal executes a web browser or a native application. Terminal records user actions, including browsing operations, search operations, and selection operations, and transmits corresponding behavior information to Server. Terminal displays, on a display device, personalized information that Server transmits.

User operates Terminal to access network resources, to input search queries, and to interact with content and recommendations. User actions on Terminal generate behavior information that forms the basis for the computations performed by Server.

Server uses a data management module to store behavior information and information resources in specific data structures. Server stores time-series behavior data as records in a storage device, for example in a log-structured store or a relational table, each record including fields such as user identifier, event type, resource identifier, timestamp, and additional attributes. Server stores information resources, such as product data or content metadata, in normalized tables or document collections with fields such as item identifier, category, attributes, and description text. Server maintains indices on user identifier and timestamp for efficient retrieval of sequential behavior, and maintains indices on item identifier and category for efficient joining of behavior data with information resources.

Server uses a feature extraction module to transform raw behavior records and information resources into feature vectors suitable for machine learning. Server constructs, for each user and for each time window, numerical and categorical features such as counts of views per category, recency of access for each category, distribution of price ranges of viewed items, frequency of specific actions such as add-to-cart or dismiss, and co-occurrence statistics between categories. Server encodes categorical fields using embedding indices, and normalizes numerical fields using precomputed scaling parameters. Server thereby generates multi-dimensional feature vectors that serve as inputs to a machine learning model.

Server uses a prediction module that implements a neural network-based machine learning model. In one embodiment, Server uses a feedforward neural network comprising an input layer, a plurality of hidden layers, and an output layer. Each hidden layer includes a plurality of units with nonlinear activation functions, such as rectified linear units. The output layer produces, for example, a vector of interest scores over a fixed set of categories or topics. Server stores learned weights and biases of the neural network in the storage device and loads them into main memory at startup. Server performs inference by executing matrix multiplications and activation functions on the feature vectors using optimized numerical libraries. Server thereby computes an interest index representing a degree of interest of the user in each category, based on patterns in the time-series behavior data that cannot be efficiently captured by simple rules.

Server trains the neural network in an offline training phase using historical behavior data stored in the storage device. Server computes a loss function such as cross-entropy loss between predicted interest distributions and ground-truth labels derived from user actions, for example, purchases or long-view events. Server updates model weights by executing a gradient-based optimization algorithm such as stochastic gradient descent or an adaptive variant. Server may perform data augmentation by sampling different time windows, randomly masking events, or perturbing event order within reasonable bounds, so that the neural network learns robust temporal patterns. By using this learning method, Server configures the neural network to capture complex, non-linear relationships between sequences of behavior events and future interests, which cannot be feasibly identified by human-defined rules.

Server integrates an emotion analysis function as a separate module or service. Server receives text information derived from behavior data, such as search queries, item titles that the user frequently views, and short reviews or feedback text. Server transforms this text into a format required by the emotion analysis module, for example by tokenizing text, lowercasing, and removing stopwords.

Server transmits the processed text to an emotion analysis engine and receives, as a response, numerical emotion scores for a plurality of emotion categories. Server may implement the emotion analysis engine as a recurrent neural network or a transformer-based model that has been trained to output emotion probabilities. Server caches emotion scores per session or per recent time window in the storage device, so that the emotion state can be reused when constructing prompt sentences without recomputing for every request.

Server uses a prompt construction module to build a prompt sentence for a generative AI model. Server combines the interest index, emotion state, and candidate related information into a textual context according to a predefined template. Server selects, from the information resources, a set of candidate related items based on high interest scores and relevance measures such as collaborative similarity or content similarity. Server then produces structured text that summarizes user behavior, such as “the user recently viewed several items in category A and category B and repeatedly searched for term X,” followed by a summary of the emotion state, such as “the user appears highly curious and moderately satisfied,” and followed by a textual listing or description of candidate related items.

Server then inserts this structured context into an instruction template, forming a complete prompt sentence for the generative AI model. In one example, Server constructs a prompt sentence such as: “The user has just searched for ‘smartphone case’, frequently views smartphone accessories and discount products, and currently shows high joy and curiosity. Using the following product list, generate three short, personalized recommendations and explain briefly why each item is suitable: [product A: description . . . ; product B: description . . . ; product C: description . . . ].”

In another example, Server constructs a prompt sentence such as:

“Based on the user's browsing history (several mid-range smartphones around a certain price) and the detected emotion of excitement, generate a concise promotional message that suggests complementary accessories and limited-time offers that match this profile.”

By embedding both behavior-derived interest indices and emotion scores, Server provides a richer and more structured input to the generative AI model than conventional prompts that only include a query or a list of items.

Server communicates with a generative AI model using a generative AI integration module. In one embodiment, Server uses a transformer-based language model deployed on a separate inference engine. The generative AI model comprises multiple layers of self-attention and feedforward sublayers. The model takes as input a tokenized representation of the prompt sentence, applies positional encodings, and processes the sequence through the transformer layers to compute contextualized embeddings. The model then predicts the next tokens step by step, thereby generating natural-language text that includes recommendation texts and explanations. Server configures the generative AI model with parameters such as maximum token length, sampling temperature, and top-k or top-p sampling thresholds to control creativity and determinism.

Server receives generated text from the generative AI model through the communication interface. Server uses a response structuring module to parse the generated text. Server may identify boundaries between recommendation items by detecting numbered lists or bullet markers, or by using auxiliary tagging tokens in the prompt sentence. Server maps segments of generated text to specific candidate items by matching item names or identifiers. Server then outputs a structured representation including recommendation target items, explanation text associated with each item, and an overall notification message.

Server uses a notification management module to deliver structured personalized information to Terminal. Server decides, based on internal policies, whether to send the personalized information immediately or to queue it for later. Server formats the notification as a message including a title, a message body, and metadata, and sends the message via a push notification service, a persistent bidirectional communication channel, or an application-level messaging protocol. Server may also control message frequency per user by storing and updating a counter or timestamp for the last notification, thereby reducing redundant transmissions and decreasing communication load on the network.

Terminal receives the notification and decodes the structured personalized information. Terminal renders a user interface component, such as a banner or card list, that contains recommendation target items and explanation text. Terminal associates item identifiers in the payload with locally cached or requested images and details and displays them. Terminal logs user actions on these components, such as clicks on recommended items, dismissal of the banner, or expansion of detailed views. Terminal aggregates these actions into additional behavior information and sends them back to Server.

Server records the additional behavior data in the storage device and uses it to update feature generation parameters or prompt construction patterns. For example, Server may increase the weight of categories whose recommended items receive frequent selection operations, and decrease the weight of categories whose items are repeatedly rejected. Server may also log which forms of prompt sentences result in higher engagement, and update the templates accordingly. Because these updates alter the subsequent neural network inputs and prompt constructions, the system implements a closed-loop adaptation mechanism that changes the internal technical behavior of the machine learning pipeline over time.

Server improves computer technology in several ways. First, by constructing prompt sentences that encode pre-computed interest indices and emotion states, Server shifts computation from the generative AI model to specialized predictive and analytical modules. This reduces the amount of trial-and-error or redundant text generation and lowers the average token length of prompts and outputs, thereby reducing processing time and resource consumption in the generative AI model. Second, by storing behavior data in a time-series structure with appropriate indices, Server can compute features and retrieve sequences in time order with fewer disk seeks and improved cache locality, which directly increases throughput for high-volume event streams. Third, by integrating emotion analysis and behavior prediction before prompt construction, Server can filter out irrelevant items and reduce the number of candidate related items to be presented in the prompt sentence. This reduces the amount of data transmitted to the generative AI model and reduces communication load between Server and the model.

Server further improves computation accuracy compared to simple rule-based recommendation. The neural network-based prediction model uses error-driven training with explicit loss functions and gradient updates, so that the interest index approximates conditional probabilities of user interest under observed patterns. The emotion analysis module similarly produces numeric scores that are statistically correlated with user feedback. By combining these values in a structured prompt sentence, Server provides the generative AI model with a context tailored to the internal structure of the transformer-based language model, which is designed to process token sequences with rich contextual dependencies. The resulting recommendations exhibit lower error rates in predicting user clicks and higher relevance scores as measured by objective metrics constructed on logged data.

Server uses non-conventional rules and procedures in prompt construction and closed-loop adaptation. Rather than simply inserting a user query into a template, Server generates multi-part prompt sentences that include an explicit description of recent temporal patterns (e.g., “in the last N minutes, the user viewed items in categories X and Y”), numeric descriptors of interest strength (e.g., “very strong interest in category X, moderate interest in category Y”), and emotion labels (e.g., “the user appears frustrated with battery life issues”). Server uses this non-standard composition to influence the attention patterns of the generative AI model, which leads to more focused generation. These techniques are specifically engineered for interaction with neural language models and do not merely mirror human manual content creation processes.

Server can adopt alternative machine learning architectures while maintaining the same overall data flow. For example, Server may implement the interest prediction module as a recurrent neural network that processes sequences of events in order, or as a temporal convolutional network that aggregates local temporal features. Server may implement the emotion analysis function either as a separate model running locally on Server or as a remote neural network service. Server may adjust model hyperparameters, such as the number of layers, hidden units, learning rate, or regularization strength, to trade off between computational cost and prediction accuracy.

Server may also employ different storage implementations. In one embodiment, Server uses a distributed key-value store for time-series logs and a columnar database for analytical queries, enabling parallel access and efficient aggregation. In another embodiment, Server uses an in-memory cache layer to store recent behavior sequences and pre-computed features, thereby reducing access latency when generating new prompt sentences.

Terminal implementations can vary as well. Terminal may be a web browser that executes scripts to monitor page interactions and communicate via standard web protocols, or may be a native application that uses a platform-specific messaging library and local storage for caching user state. Terminal may support different user interface components, such as full-screen recommendation pages, compact banners, or inline suggestion panels.

By tying together these modules into a specific architecture and algorithmic flow, the system does more than automate a human task. The system organizes data structures for time-series events, defines machine learning models with explicit architectures and training methods, constructs prompt sentences with structured contexts, and controls network communication patterns in order to achieve concrete technical effects: reduced processing latency, improved memory usage, lower network bandwidth consumption, and increased accuracy of content selection within the computer system. These effects are realized within Server's hardware resources and are independent of subjective user perception, thereby satisfying requirements that the invention improve the functioning of the computer system itself.

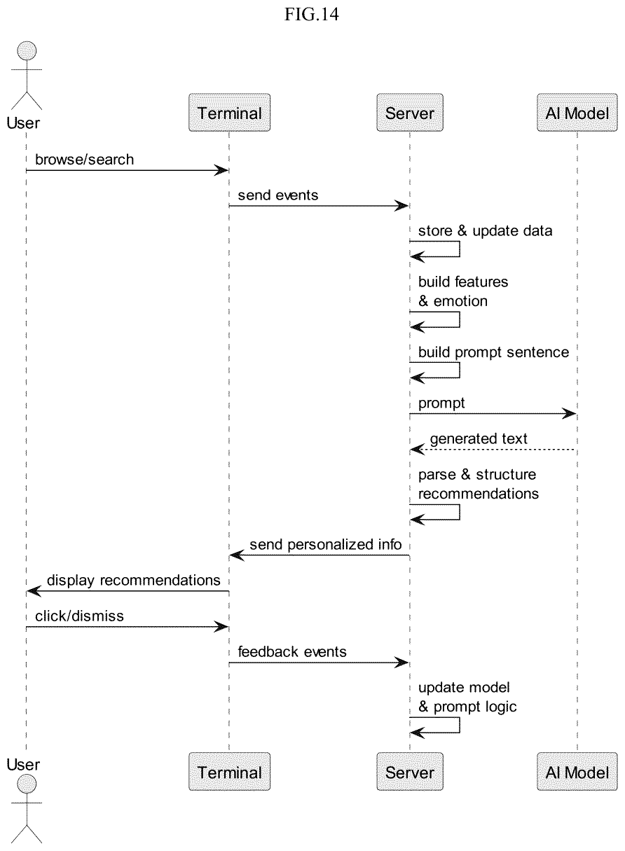

The following describes the processing flow using FIG. 14.

### Step 1

User operates Terminal to access a network application, input search queries, and interact with content.

Terminal records, as input, low-level interaction signals such as page URLs, search strings, item identifiers, click coordinates, scroll positions, timestamps, and session identifiers.

Terminal aggregates these signals into structured behavior information, for example a record including fields {user_id, session_id, event_type, resource_id, query_text, timestamp, additional_attributes}.

Terminal performs data processing by normalizing encodings (e.g., converting character sets, trimming whitespace), assigning event types (e.g., “page_view”, “search”, “item_click”), and attaching a precise timestamp obtained from a local clock.

Terminal outputs a serialized event payload, typically in a text-based format, and transmits the payload to Server via a secure communication protocol.

### Step 2

Server receives, as input, the event payload transmitted from Terminal through a network interface.

Server parses the payload into an internal data structure, validates required fields (e.g., user_id, timestamp), and discards malformed records.

Server enriches the event with additional attributes such as network address, device type, and application version, by inspecting transport headers and stored session metadata.

Server performs data processing by converting timestamps to a unified time zone, mapping device identifiers to device categories, and assigning a monotonically increasing sequence number to preserve event order.

Server outputs a validated and enriched event object and forwards this event object to a data management module and an event streaming pipeline.

### Step 3

Server uses the data management module to store, as input, the enriched event object together with existing time-series behavior data and information resources.

Server writes the event into a time-ordered storage structure, for example an append-only log table, and updates indices keyed by user identifier and timestamp.

Server retrieves, as additional input, one or more information resource records (e.g., product or content entries) that correspond to any resource_id contained in the event by executing index-based lookups.

Server performs data processing by associating the event with the retrieved information resources, generating a joint record that includes both user behavior attributes and item attributes.

Server outputs an updated time-series dataset and a set of joint records that are ready for feature extraction.

### Step 4

Server receives, as input, the joint records for a target user over a defined time window.

Server uses a feature extraction module to group events by user and by category, and computes numerical features such as counts of events per category, recency scores based on timestamp decay functions, average price and variance for viewed items, and ratios of positive interactions to negative interactions.

Server also encodes categorical attributes, such as category identifiers and device types, into integer indices and, optionally, maps them into embedding indices according to a pre-defined vocabulary.

Server performs data processing by stacking these numerical and categorical representations into a fixed-length feature vector per user or per user-session, normalizing values by applying scale and offset parameters learned during training.

Server outputs a feature matrix or a collection of feature vectors that represent the behavioral and contextual profile of the user.

### Step 5

Server inputs the feature vectors into a prediction module that implements a neural network-based machine learning model.

Server performs a forward pass through the neural network, executing matrix multiplications between feature vectors and learned weight matrices in successive layers, adding bias vectors, and applying nonlinear activation functions to intermediate results.

Server computes, at the output layer, a vector of predicted scores representing an interest index for various categories, topics, or item clusters.

Server post-processes these scores by applying normalization functions such as softmax or by clipping and scaling to a fixed range.

Server outputs an interest index profile that quantitatively expresses the user's predicted interest distribution.

### Step 6

Server receives, as input, text information and usage-situation information derived from recent behavior data, including search queries, titles of frequently viewed items, and short feedback messages.

Server feeds this information into an emotion analysis function, which may include a text preprocessing submodule that tokenizes words, removes stopwords, and maps tokens to embeddings.

Server executes an emotion classifier model on the processed text, for example a recurrent neural network or transformer encoder, and computes probability values or scores for a predefined set of emotion categories.

Server aggregates emotion scores over a time window by averaging or applying a weighted combination that emphasizes recent events.

Server outputs a structured emotional state representation, including emotion labels and corresponding indices or scores.

### Step 7

Server uses the interest index profile and emotional state representation as input to a candidate selection process.

Server queries stored information resources to retrieve candidate items whose categories, attributes, or similarity metrics match high-scoring entries in the interest index.

Server applies filtering rules that exclude items inconsistent with the current emotional state or with recent negative feedback patterns, for example by removing items from categories repeatedly rejected by the user.

Server performs ranking by combining interest scores, relevance measures, and diversity constraints to produce an ordered list of candidate related items.

Server outputs an ordered candidate list, where each candidate includes an item identifier, key attributes, and a relevance score.

### Step 8

Server receives, as input, the interest index profile, the emotional state representation, and the ordered candidate list.

Server invokes a prompt construction module that generates human-readable textual descriptions of recent user behavior, such as “the user recently viewed multiple items in category X and searched for phrase Y”, and textual summaries of the emotional state, such as “the user appears highly curious about new technology”.

Server converts selected candidate items into compact textual descriptors that include item names, categories, and salient features, and assembles them as a list within the text.

Server concatenates the behavior description, the emotional summary, and the candidate descriptors into a structured instruction according to a template, thereby forming a prompt sentence for the generative AI model.

Server outputs a complete prompt sentence, for example:

“The user has just searched for ‘smartphone case’, frequently views smartphone accessories and discount products, and currently shows high joy and curiosity. Using the following product list, generate three short, personalized recommendations and explain briefly why each item is suitable: [product A: description . . . ; product B: description . . . ; product C: description . . . ].”

### Step 9

Server sends, as input, the constructed prompt sentence to a generative AI model via the communication interface.

Server tokenizes the prompt sentence into tokens according to the vocabulary of the generative AI model and transmits the token sequence, along with generation parameters such as maximum output length and sampling configuration, to the model.

Server receives, as output from the generative AI model, a sequence of generated tokens that represent natural-language text including recommendation statements, explanations, and possibly structured cues such as numbered items.

Server decodes the token sequence into text, detects boundaries between individual recommendations by scanning for numeric markers or punctuation, and associates each text segment with corresponding candidate items based on name or attribute matching.

Server outputs parsed recommendation content including, for each item, recommendation text and explanation text, as well as an overall notification message.

### Step 10

Server inputs the parsed recommendation content into a response structuring module.

Server constructs a structured payload that organizes the content into fields such as notification_title, notification_body, and a list of recommendation target items, each including an item identifier, recommendation reason, and any computed promotion flags.

Server may further augment the payload with presentation hints, such as priority level or display style, in accordance with internal rules or user preferences.

Server outputs a finalized structured personalized information object that can be consumed by Terminal for display.

### Step 11

Server transmits, as input to Terminal, the structured personalized information object through a messaging channel, such as a push notification service or a bidirectional communication protocol.

Server schedules the transmission according to rate-limiting policies and, optionally, updates internal counters or timestamps that record the last notification time per user.

Server monitors for delivery acknowledgments or error responses from Terminal and, if necessary, logs transmission status in storage to support retry mechanisms.

Server outputs a delivery result status for internal monitoring and leaves the personalized information ready for rendering on Terminal.

### Step 12

Terminal receives, as input, the structured personalized information object and decodes it into internal data structures.

Terminal maps item identifiers in the payload to visual representations, such as retrieving cached images or requesting item details from Server if not present locally.

Terminal constructs one or more user interface components, such as a banner, a pop-up, or a recommendation list, using the notification_title, notification_body, and recommendation reasons.

Terminal performs data processing by arranging elements according to layout rules, truncating text to fit display constraints, and attaching interaction handlers (e.g., click listeners) to each recommendation item.

Terminal outputs a rendered view on a display device that presents the personalized information to User.

### Step 13

User views the rendered personalized information on Terminal and performs actions such as selecting a recommended item, expanding additional details, or dismissing the notification.

Terminal captures, as input, these actions as new interaction events that include event_type (e.g., “recommendation_click”, “recommendation_dismiss”), associated item identifiers, timestamps, and context identifiers.

Terminal aggregates these interaction events into additional behavior information and applies lightweight preprocessing, such as normalizing event labels and attaching the identifier of the originating personalized information message.

Terminal outputs updated behavior information and transmits it to Server using the same communication mechanisms used for earlier events.

### Step 14

Server receives, as input, the additional behavior information indicating how User interacted with the personalized information.

Server records these events in the time-series behavior data store, associating them with prior recommendation sessions by storing identifiers that link each interaction event to a corresponding prompt sentence and generative AI output.

Server performs data processing by computing outcome metrics, such as click-through rate and dismissal rate, per category or per prompt template, and aggregates these metrics over time.

Server uses these metrics to adjust feature weighting rules, to update hyperparameters of the prediction model during retraining, or to modify prompt construction templates, thereby changing thresholds for candidate selection or altering textual phrasing.

Server outputs updated model parameters, feature generation parameters, or template configurations, which will be applied in subsequent executions of Steps 4 through 10 to refine the interest index, the emotional representation, and the prompt sentence used for the generative AI model.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

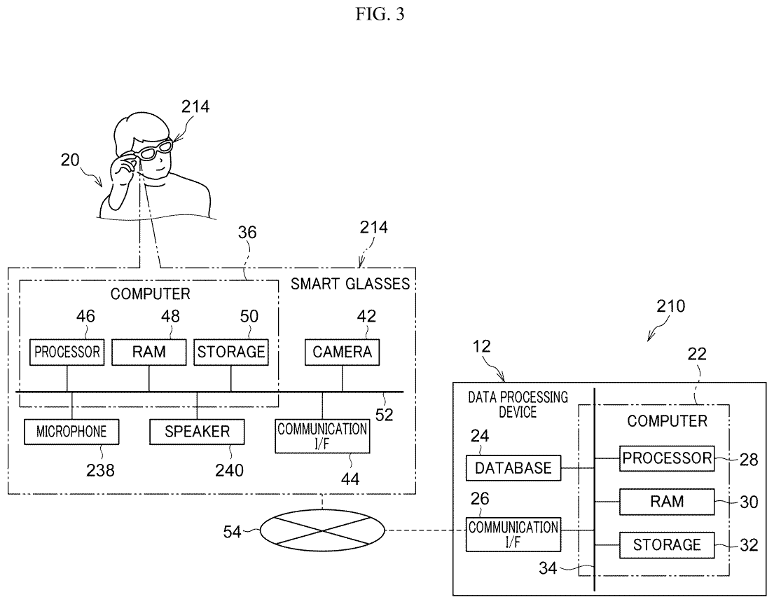

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

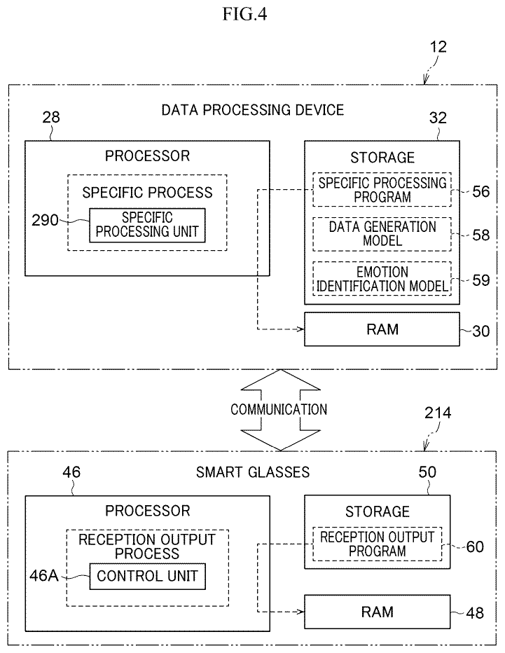

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

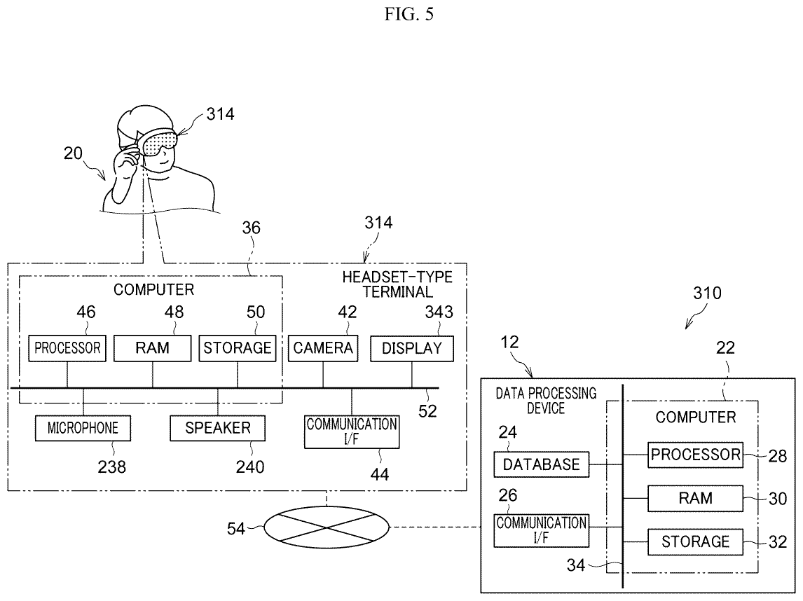

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

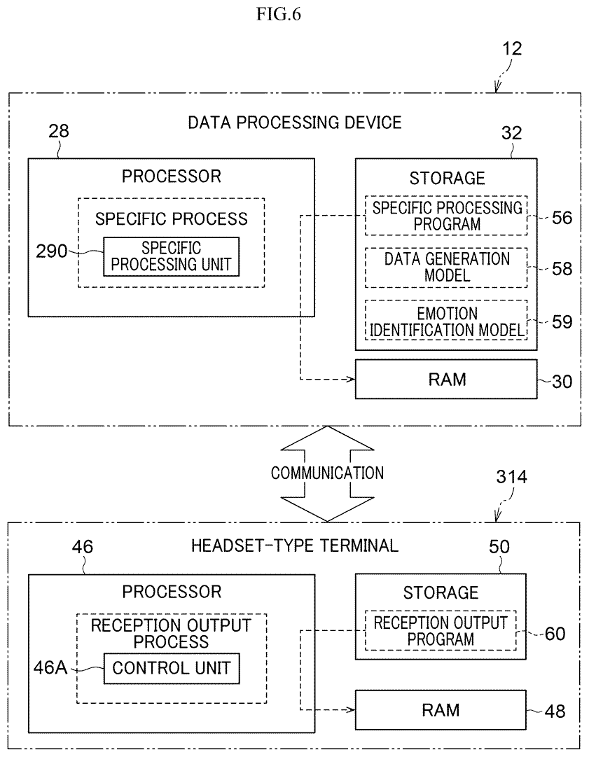

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

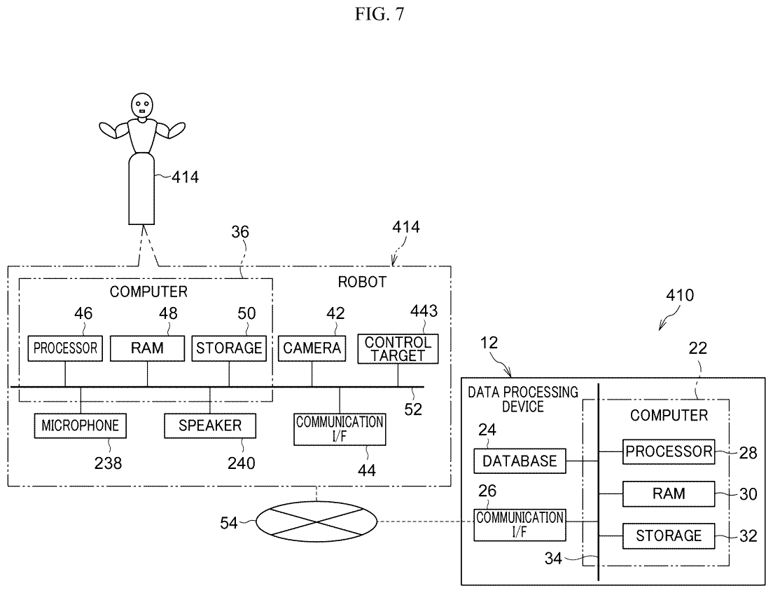

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

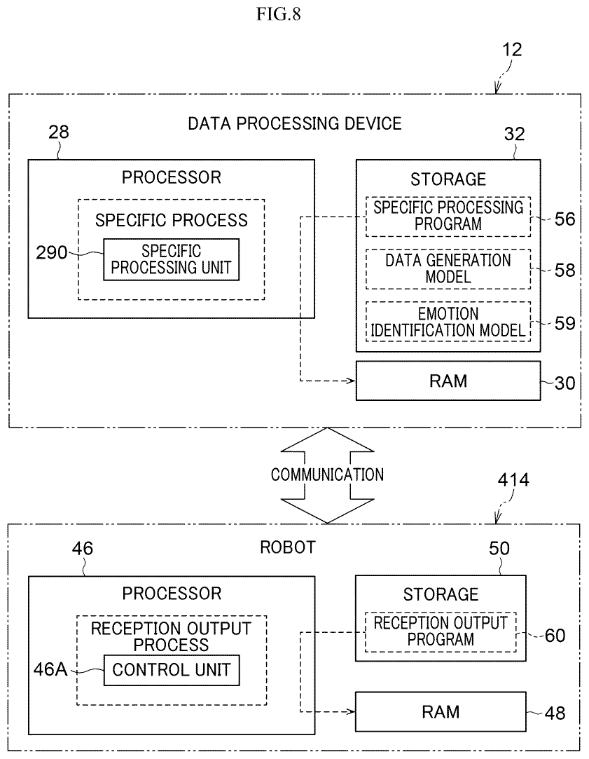

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

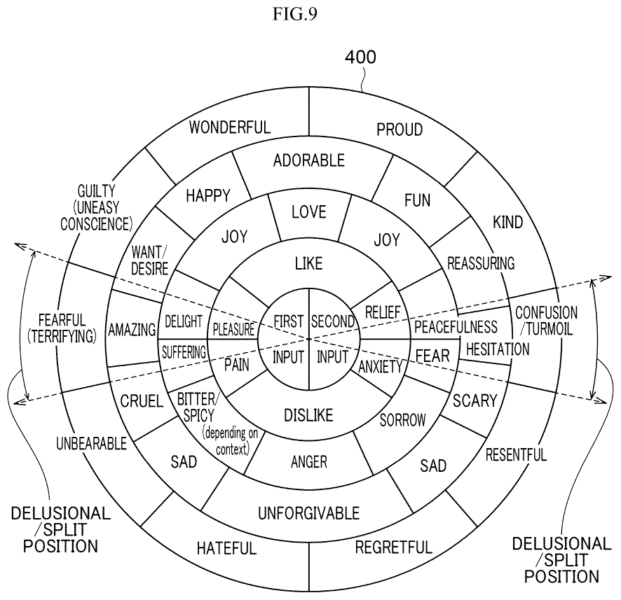

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

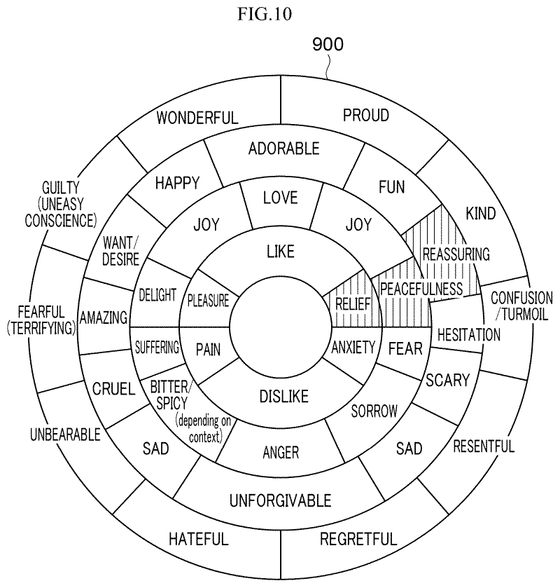

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
acquire, from one or more information acquisition units, user behavior information and information resource information, and generate, for each user, characteristic information indicating user interests, and
automatically generate a prompt sentence for a generative AI model on the basis of the characteristic information and context information relating to an information resource currently being browsed by the user, and provide an instruction to use the prompt sentence as input to the generative AI model, and
retrieve, from an information management apparatus that stores organization-owned information, organization-owned information related to the prompt sentence and the characteristic information, and
provide, to the generative AI model, integrated input information including the prompt sentence, the characteristic information, the organization-owned information, and content information relating to the information resource currently being browsed by the user, and cause the generative AI model to generate integrated information based on the integrated input information, and
transmit the integrated information to a user terminal and cause the user terminal to visually present the integrated information in association with the information resource currently being browsed by the user, and
acquire operation information and reaction information of the user with respect to the integrated information, and update the characteristic information and generation conditions of the prompt sentence on the basis of the acquired operation information and reaction information.

### Supplementary 2

The system according to supplementary 1,
wherein the processor is configured to
obtain history information, including behavior history information and search history information, from a data storage apparatus, extract topic information, phrase information, and entity information from the history information by using a natural language processing method, structure the extracted information as the characteristic information, and use the structured characteristic information for automatic generation of the prompt sentence.

### Supplementary 3

The system according to supplementary 1,
wherein the processor is configured to
cause a display unit of the user terminal to present the integrated information in a display area that is separate from a display area in which the information resource currently being browsed by the user is presented, as a popup display or a sidebar display, and
treat, as the operation information, at least a selection operation, a detail request operation, and a non-relevance designation operation with respect to display content of the integrated information, and
change weights of the topic information and the phrase information based on the operation information, and adapt a subsequently generated prompt sentence to content reflecting the changed weights.

### Application Example 1

### Supplementary 1

A system comprising a processor and a storage unit,
wherein the processor is configured to
store, in the storage unit, user behavior information and organization-held information including inventory information and sales promotion information,
analyze the user behavior information stored in the storage unit to extract preference information of a user, select candidate item information including the inventory information and the sales promotion information in accordance with the preference information, and generate a prompt sentence in a natural language format by integrating the preference information and the candidate item information,
transmit the prompt sentence as input data to a generative AI model and instruct the generative AI model to generate personalized item recommendation information,
analyze the personalized item recommendation information received from the generative AI model and convert the personalized item recommendation information into recommendation result data including item identification information and explanation information that are consistent with the candidate item information,
transmit the recommendation result data to a user terminal and perform communication processing such that the personalized item recommendation information is displayed on the user terminal, and
acquire, from the user terminal, user reaction information to the personalized item recommendation information as additional user behavior information, store the additional user behavior information in the storage unit, and reuse the stored additional user behavior information for generation of a subsequent prompt sentence.

### Supplementary 2

The system according to supplementary 1,
wherein the processor is configured to
analyze browsing history information and search history information included in the user behavior information to estimate an interest field and a price range of the user, and explicitly describe an estimation result as user profile information in the prompt sentence.

### Supplementary 3

The system according to supplementary 1,
wherein the processor is configured to
extract, from the organization-held information including the inventory information and the sales promotion information, an item that satisfies a predetermined stock condition within an effective period of a sales promotion, enumerate extraction results as the candidate item information in the prompt sentence, and instruct the generative AI model to select, from among the candidate item information, an item suitable for the preference information of the user.

### Example 2

### Supplementary 1

A system comprising a processor,
wherein the processor is configured to
acquire, by using an input/output device operating on an information processing apparatus, behavior information based on operations of a user and transmit data including the behavior information to a server via a communication network,
store, in a storage device of the server, the data including the behavior information, and integrate, by using a database management function, the stored behavior information with item information and sales policy information stored in advance in the storage device to generate an integrated data set,
generate, by using a template processing function, a prompt sentence for input to a generative information processing model having natural language processing functionality, the prompt sentence being based on the integrated data set, and transmit the prompt sentence to the generative information processing model via the communication network to instruct generation of personalized useful information for the user,
receive, from the generative information processing model, the useful information generated in response to the prompt sentence, convert the useful information into display data for a screen display, and transmit the display data to the input/output device so that the useful information is presented to a user terminal in real time or quasi-real time, and
control repeated execution of updating the integrated data set and regenerating the prompt sentence by causing the user terminal to transmit, to the server, additional behavior information regarding viewing or selection of the useful information on the user terminal.

### Supplementary 2

The system according to supplementary 1,
wherein the processor is configured to, when generating the integrated data set, aggregate, for each user and for a predetermined period, viewing category, number of views, dwelling time, price range, and purchase history, calculate feature values indicating a category of interest of the user, a preferred price range, and focused viewed items based on the aggregation, and include the feature values in the prompt sentence.

### Supplementary 3

The system according to supplementary 1,
wherein the processor is configured to analyze text of the useful information received from the generative information processing model, extract at least a recommended category, an identifier of a candidate item, and discount information from the text, and generate display control data for a user terminal based on the extracted information by associating recommended information with a recommendation display region on the user terminal and associating sales policy information with a sales information display region on the user terminal.

### Application Example 2

### Supplementary 1

A system comprising a processor, a storage device, and a communication interface,
wherein the processor is configured to
provide, via the communication interface, an information input and output function for receiving behavior information and request information from a user terminal operated by a user,
store, in the storage device by using a data management function, browsing history, search history, and operation history received from the user terminal as time-series behavior data, and associate and combine the behavior data with information resources held by an information providing entity,
generate, from the combined behavior data and the information resources, feature values and prediction results by using a machine learning model so as to calculate an interest index of the user,
estimate an emotional state of the user by using an emotion analysis function, and construct a prompt sentence for a generative AI model by embedding the interest index, the emotional state, and candidate related information into a textual context,
input the constructed prompt sentence into the generative AI model via the communication interface, receive output information from the generative AI model, analyze the output information, and
structure the output information as personalized information including recommendation target items, explanation text, and notification messages,
transmit the structured personalized information to the user terminal in real time by using a message distribution function, an interactive communication function, or a notification management function via the communication interface, so that the personalized information is presented to the user through display processing of the user terminal, and
acquire, from the user terminal, additional behavior data including selection operations, viewing operations, or rejection operations performed by the user with respect to the personalized information, and update, on the basis of the additional behavior data, the feature value generation and the construction of the prompt sentence so as to continuously improve information generation processing performed by the generative AI model.

### Supplementary 2

The system according to supplementary 1,
wherein the processor is configured to generate, in the construction of the prompt sentence, summary information indicating information categories, price ranges, time periods, and usage situations for which the user has shown interest, based on the browsing history and the search history extracted from the behavior data, and to use, as an input to the generative AI model, a textual context including the summary information together with candidate information obtained from the information resources, thereby instructing generation of the personalized information.

### Supplementary 3

The system according to supplementary 1,
wherein the processor is configured to estimate, by the emotion analysis function, the emotional state using text information and usage-situation information including search words of the user, content being browsed, and behavior patterns, and to include indices and labels representing the estimated emotional state in the prompt sentence so as to instruct the generative AI model to generate expression content and recommendation content adapted to the emotional state of the user.

What is claimed is:

1. A system comprising:
circuitry configured to:
receive, via a communication interface coupled to a packet-switched network, time-series behavior data transmitted from a terminal device, and generate characteristic information representing inferred attributes of the terminal device based on the time-series behavior data;
construct a natural-language prompt sentence for a generative neural network model based on the characteristic information and context data associated with an information resource currently accessed by the terminal device;
retrieve, from a storage device, organization-held information related to the characteristic information, and provide the generative neural network model with integrated input data comprising the natural-language prompt sentence, the characteristic information, the organization-held information, and the context data, and obtain generated output data from the generative neural network model;
transmit the generated output data to the terminal device via the communication interface for rendering in association with the information resource; and
receive, from the terminal device, interaction data indicating operations performed with respect to the generated output data, and update the characteristic information and generation conditions of the natural-language prompt sentence based on the interaction data.

2. The system according to claim 1, wherein the circuitry is further configured to obtain history information including behavior history information and search history information from the storage device, and extract topic information, phrase information, and entity information from the history information by using a natural language processing method to generate the characteristic information as a structured representation of the extracted topic information, phrase information, and entity information.

3. The system according to claim 2, wherein the circuitry is configured to maintain, for each terminal device, a short-term interest representation based on behavior data within a predetermined recent time window and a long-term interest representation based on behavior data accumulated over a period exceeding the predetermined recent time window, and to construct the natural-language prompt sentence by combining the short-term interest representation and the long-term interest representation with the context data.

4. The system according to claim 3, wherein the circuitry is configured to programmatically refine the natural-language prompt sentence in response to feedback signals derived from the interaction data by adjusting weights associated with the topic information and the phrase information in the characteristic information, and to adapt a subsequently constructed natural-language prompt sentence to reflect the adjusted weights.

5. The system according to claim 4, wherein the characteristic information includes an interest index calculated from browsing category distributions, view counts, dwelling time values, and a price range derived from the behavior history information, and the circuitry is configured to embed the interest index as a feature value within the natural-language prompt sentence.

6. The system according to claim 1, wherein the organization-held information includes inventory information and sales promotion information stored in the storage device, and the circuitry is configured to select candidate item information from the inventory information in accordance with the characteristic information and to include the candidate item information and the sales promotion information in the integrated input data provided to the generative neural network model.

7. The system according to claim 6, wherein the circuitry is configured to analyze the generated output data received from the generative neural network model and convert the generated output data into recommendation result data including item identification information and explanation information that are consistent with the candidate item information, and to validate the recommendation result data against the inventory information to confirm item availability before transmitting to the terminal device.

8. The system according to claim 7, wherein the circuitry is configured to acquire, from the terminal device, user reaction information including selection operations, detail request operations, and non-relevance designation operations with respect to the recommendation result data, store the user reaction information as additional time-series behavior data in the storage device, and reuse the additional time-series behavior data for generation of a subsequent natural-language prompt sentence.

9. The system according to claim 1, wherein the circuitry is further configured to transmit display control data to the terminal device that causes the terminal device to render the generated output data in a display area that is separate from a display area in which the information resource currently accessed by the terminal device is presented.

10. The system according to claim 9, wherein the display control data specifies at least one of a popup display mode and a sidebar display mode for the generated output data, and the circuitry is configured to associate recommendation display content with a first display region and supplementary information with a second display region within the display area.

11. The system according to claim 10, wherein the circuitry is configured to detect, based on the interaction data, at least one of a selection operation, a detail request operation, and a dismissal operation performed by a user with respect to display content within the display area, and to transmit updated generated output data to the terminal device in response to the detected operation without requiring a new request from the terminal device.

12. The system according to claim 1, wherein the circuitry is further configured to receive, from the terminal device, user state data comprising at least one of text-based sentiment indicators, voice data captured by an audio sensor, and image data captured by an imaging sensor, and estimate an emotional state by inputting the user state data to an emotion identification model that maps input feature vectors to emotion values on an emotion map having a valence dimension and an arousal dimension.

13. The system according to claim 12, wherein the circuitry is configured to embed the estimated emotional state as an additional parameter in the natural-language prompt sentence, and to instruct the generative neural network model to adapt content and tone of the generated output data in accordance with the estimated emotional state.

14. The system according to claim 1, wherein the circuitry is further configured to monitor the time-series behavior data in real time and detect a change in the characteristic information that exceeds a predetermined threshold, and, responsive to the detected change, automatically reconstruct the natural-language prompt sentence and obtain updated generated output data from the generative neural network model without requiring an explicit request from the terminal device.

15. The system according to claim 14, wherein the circuitry is configured to transmit the updated generated output data to the terminal device via at least one of a push notification channel, an interactive communication channel, and a message distribution channel coupled to the packet-switched network.

16. The system according to claim 1, wherein the terminal device comprises one of a smart device, smart glasses, a headset-type terminal, or a robot, and the circuitry is configured to transmit the generated output data in a format adapted to an output modality of the terminal device.

17. The system according to claim 16, wherein the circuitry is further configured to aggregate the time-series behavior data from a plurality of terminal devices associated with a same user identifier, generate a unified characteristic information set from the aggregated time-series behavior data, and construct the natural-language prompt sentence based on the unified characteristic information set.

18. A system comprising:
circuitry configured to:
receive, via a communication interface coupled to a packet-switched network, time-series behavior data transmitted from a terminal device, the time-series behavior data including browsing history, search history, and operation history, and generate characteristic information by extracting topic information, phrase information, and entity information from the time-series behavior data using a natural language processing method and calculating an interest index from browsing category distributions, view counts, and dwelling time values;
construct a natural-language prompt sentence for a generative neural network model by embedding the characteristic information, the interest index, and context data associated with an information resource currently accessed by the terminal device into a textual context;
retrieve, from a storage device, organization-held information related to the characteristic information, and provide the generative neural network model with integrated input data comprising the natural-language prompt sentence, the characteristic information, the organization-held information, and the context data, and obtain generated output data from the generative neural network model;
receive user state data from the terminal device, estimate an emotional state by inputting the user state data to an emotion identification model that maps input feature vectors to emotion values on an emotion map having a valence dimension and an arousal dimension, and embed the estimated emotional state as an additional parameter in a reconstructed natural-language prompt sentence to obtain emotion-adapted generated output data;
transmit the generated output data or the emotion-adapted generated output data to the terminal device via the communication interface for rendering in a display area separate from the information resource; and
receive, from the terminal device, interaction data including selection operations, detail request operations, and dismissal operations, update the characteristic information and generation conditions of the natural-language prompt sentence based on the interaction data, and automatically reconstruct the natural-language prompt sentence when a change in the characteristic information exceeds a predetermined threshold.

19. The system according to claim 18, wherein the organization-held information includes inventory information and sales promotion information, and the circuitry is further configured to select candidate item information from the inventory information in accordance with the characteristic information, include the candidate item information in the integrated input data, analyze the generated output data to extract item identification information and explanation information, and validate the extracted item identification information against the inventory information before transmitting to the terminal device.

20. A method performed by circuitry of a server coupled to a packet-switched network via a communication interface, the method comprising:
receiving, via the communication interface, time-series behavior data transmitted from a terminal device, and generating characteristic information representing inferred attributes of the terminal device based on the time-series behavior data;
constructing a natural-language prompt sentence for a generative neural network model based on the characteristic information and context data associated with an information resource currently accessed by the terminal device;
retrieving, from a storage device, organization-held information related to the characteristic information, and providing the generative neural network model with integrated input data comprising the natural-language prompt sentence, the characteristic information, the organization-held information, and the context data, and obtaining generated output data from the generative neural network model;
transmitting the generated output data to the terminal device via the communication interface for rendering in association with the information resource; and
receiving, from the terminal device, interaction data indicating operations performed with respect to the generated output data, and updating the characteristic information and generation conditions of the natural-language prompt sentence based on the interaction data.
